(19) United States
(12) Patent Application Publication
(10) Pub. No.: US 2006/0167184 A1
(43) Pub. Date: Jul. 27, 2006

(54) Innerliners for use in tires

(76) Inventors: Walter H. Waddell, Pasadena, TX (US); S. Tracey Donald, Kingwood, TX (US); W. Botfeld Stuart, Tampa, FL (US); Dirk F. Rouckhout, Linter (BE)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/323,747

(22) Filed: Dec. 30, 2005

Related U.S. Application Data
(63) Continuation-in-part of application No. 10/518,886, filed on Dec. 21, 2004.
(63) Continuation-in-part of application No. 10/398,255, filed on Apr. 3, 2003.
(63) Continuation-in-part of application No. 09/691,764, filed on Oct. 18, 2000, now Pat. No. 6,710,116.
(60) Provisional application No. 60/396,497, filed on Jul. 17, 2002.
(60) Provisional application No. 60/294,808, filed on May 31, 2001.

(51) Int. Cl. C08F 8/00; C08K 5/01

(52) U.S. Cl. 525/192; 525/196; 524/490

(57) ABSTRACT

The invention discloses tires including innerliners, the innerliners made from at least one polybutene processing aid and at least one elastomer having C₄ to C₇ isoolefin derived units.

### CROSS REFERENCE TO RELATED APPLICATIONS

This application is:

a continuation-in-part of Ser. No. 10/518,886, filed Dec. 21, 2004, which is a National Stage Application of International Application No. PCT/US2003/016947, filed May 30, 2003, which claims the benefit of Provisional Application No. 60/396,497, filed Jul. 17, 2002; and

a continuation-in-part of Ser. No. 10/398,255, filed Apr. 3, 2003, which is a National Stage Application of International Application No. PCT/US2001/42767, filed Oct. 16, 2001, which claims the benefit of Provisional Application No. 60/294,808, filed May 31, 2001, and is a continuation-in-part of Ser. No. 09/691,764, filed Oct. 18, 2000, now U.S. Pat. No. 6,710,116;

the disclosures of which are incorporated by reference.

### FIELD OF THE INVENTION

The present invention relates to blends of C₄ to C₇ isoolefin based polymers with a polybutene processing aid used as an additive for use in air barriers in one aspect of the composition. In particular, the present invention relates to compositions including at least one halogenated random copolymer of isobutylene and isoprene with a polybutene processing aid. In particular, the present invention relates to compositions including at least one halogenated random copolymer of isobutylene and methylstyrene, preferably para-methylstyrene; wherein the at least one halogenated random copolymer includes at least 9.0 wt % methylstyrene, preferably para-methylstyrene, based upon the weight of the at least one halogenated random copolymer; and a polybutene processing aid. The invention also relates to articles made from these compositions and processes for making the same. More particularly the invention relates to a halogenated C₄ to C₇ isoolefin based polymer component composition blended with a polybutene processing aid to form an air barrier such as a tire innerliner.

### BACKGROUND OF THE INVENTION

Halobutyl rubbers, which are isobutylene-based copolymers of C₄ to C₇ isoolefins and multiolefins, are the polymers of choice for best air-retention in tires for example in automobile, truck, bus and aircraft vehicles. See, for example, U.S. Pat. No. 5,922,153 and U.S. Pat. No. 5,491,196, and EP 0 102 844 and 0 127 998. Bromobutyl rubber, chlorobutyl rubber, halogenated star-branched butyl rubbers, and halogenated random copolymers of isobutylene and methylstyrene, preferably para-methylstyrene, can be formulated for these specific applications. The selection of ingredients and additives for the final commercial formulation depends upon the balance of properties desired. Namely, processing properties of the green (uncured) compound in the tire plant versus the in-service performance of the cured tire composite, as well as the nature of the tire

The tire industry continually seeks improvements to past applications. For example, EXXPRO™ elastomers (ExxonMobil Chemical Company, Houston, Tex.), generally, halogenated random copolymers of isobutylene and para-methylstyrene, have been of particular interest due to their improvements over butyl rubbers. See, e.g., U.S. Pat. No. 6,293,327, and U.S. Pat. No. 5,386,864, U.S. Patent Application Publication No. 2002/151636, JP 2003170438, and JP 2003192854 (applying various approaches of blends of commercial EXXPRO™ elastomers with other polymers).

See also U.S. Pat. No. 5,063,268, U.S. Pat. No. 5,391,625, U.S. Pat. No. 6,051,653, and U.S. Pat. No. 6,624,220, WO 1992/02582, WO 1992/03302, WO 2004/058825, EP 1 331 107 A, and EP 0 922 732 A.

Further, while it is known that the addition of plasticizers such as aromatic-containing processing oils will increase the air permeability of polymers, (see, e.g., POLYMER PERMEABILITY 61-62 (J. Comyn ed., Elsevier Applied Science 1986); U.S. Pat. No. 4,279,284 (water vapor permeability) and U.S. Pat. No. 6,326,433 B1 (air permeability)), the inventors of the presently disclosed air barrier compositions have surprisingly found that polybutene processing aids can be used in certain formulations described herein to improve air barrier qualities by decreasing the air permeability, while maintaining other desirable properties of the compositions.

Other disclosures of processing oil or resin-containing elastomeric or adhesive compositions include U.S. Pat. No. 5,005,625, U.S. Pat. No. 5,013,793, U.S. Pat. No. 5,162,409, U.S. Pat. No. 5,178,702, U.S. Pat. No. 5,234,987, U.S. Pat. No. 5,234,987, U.S. Pat. No. 5,242,727, U.S. Pat. No. 5,397,832, U.S. Pat. No. 5,733,621, and U.S. Pat. No. 5,755,899, EP 0 682 071 A1, EP 0376 558B1, WO 92/16587, JP11005874, JP05179068A and JO3028244.

Other background references include U.S. Pat. No. 5,157,081 A, WO 02/32992, and EP 0 992 538 A.

Polybutene processing aids have been disclosed in U.S. Pat. No. 4,279,284 to Spadone, and U.S. Pat. No. 5,964,969 to Sandstrom et al., and EP 0 314 416 to Mohammed. None of these disclosures solves the problem of improving processability of elastomeric compositions useful for tires, air barriers, etc, while maintaining or improving the air impermeability of those compositions. What is lacking in the art is an air barrier that has suitable processing properties and cure properties such as green strength, modulus, tensile strength, and hardness, while maintaining adequate or improving air impermeability provided by halogenated isobutylene rubbers. The present invention solves this and other problems.

### SUMMARY OF THE INVENTION

In one aspect, the invention provides a composition suitable for an air barrier such as a tire innertube or innerliner for automotive, truck, bus, and aircraft vehicles, curing bladders, and other pneumatic devices. The composition comprises an elastomer comprising C₄ to C₇ isoolefin derived units; and a polybutene processing aid. In a desirable embodiment, naphthenic and aromatic oils are substantially absent from the composition. Further, in yet another embodiment, a secondary rubber is also present such as, for example, natural rubber or butyl rubber, or a butadiene-based rubber.

In another aspect, the invention provides for a tire comprising an innerliner, the innerliner made from at least one polybutene processing aid and at least one elastomer, the elastomer comprising C₄ to C₇ isoolefin derived units.

### DETAILED DESCRIPTION OF THE INVENTION

Various specific embodiments, versions and examples of the invention will now be described, including preferred embodiments and definitions that are adopted herein for purposes of understanding the claimed invention.

In reference to Periodic Table “Groups”, the new numbering scheme for the Periodic Table Groups is used as found in HAWLEY'S CONDENSED CHEMICAL DICTIONARY, P 852 (13th ed. 1997).

Slurry refers to a volume of diluent comprising polymers that have precipitated from the diluent, monomers, Lewis acid, and initiator. The slurry concentration is the volume percent of the partially or completely precipitated polymers based on the total volume of the slurry.

Polymer may be used to refer to homopolymers, copolymers, interpolymers, terpolymers, etc. Likewise, a copolymer may refer to a polymer comprising at least two monomers, optionally with other monomers.

When a polymer is referred to as comprising a monomer, the monomer is present in the polymer in the polymerized form of the monomer or in the derivative form the monomer. However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

Rubber refers to any polymer or composition of polymers consistent with the ASTM D1566 definition: “a material that is capable of recovering from large deformations, and can be, or already is, modified to a state in which it is essentially insoluble (but can swell) in boiling solvent . . . ”. Elastomer is a term that may be used interchangeably with the term rubber.

Elastomeric composition refers to any composition comprising at least one elastomer as defined above.

A vulcanized rubber compound by ASTM D1566 definition refers to “a crosslinked elastic material compounded from an elastomer, susceptible to large deformations by a small force capable of rapid, forceful recovery to approximately its original dimensions and shape upon removal of the deforming force”. A cured elastomeric composition refers to any elastomeric composition that has undergone a curing process and/or comprises or is produced using an effective amount of a curative or cure package, and is a term used interchangeably with the term vulcanized rubber compound.

A thermoplastic elastomer by ASTM D1566 definition refers to a rubber-like material “that repeatedly can be softened by heating and hardened by cooling through a temperature range characteristic of the polymer, and in the softened state can be shaped into articles”. Thermoplastic elastomers are microphase separated systems of at least two polymers. One phase is the hard polymer that does not flow at room temperature, but becomes fluid when heated, that gives thermoplastic elastomers its strength. The other phase is a soft rubbery polymer that gives thermoplastic elastomers their elasticity. The hard phase is typically the major or continuous phase.

A thermoplastic vulcanizate by ASTM D1566 definition refers to “a thermoplastic elastomer with a chemically cross-linked rubbery phase, produced by dynamic vulcanization”. Dynamic vulcanization is “the process of intimate melt mixing of a thermoplastic polymer and a suitable reactive rubbery polymer to generate a thermoplastic elastomer with a chemically cross-linked rubbery phase . . . ”. The rubbery phase, whether or not cross-linked, is typically the minor or dispersed phase.

The term “phr” is parts per hundred rubber or “parts”, and is a measure common in the art wherein components of a composition are measured relative to a total of all of the elastomer components. The total phr or parts for all rubber components, whether one, two, three, or more different rubber components is present in a given recipe is always defined as 100 phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percents for every component after adjusting levels of only one, or more, component(s).

Isoolefin refers to any olefin monomer having at least one carbon having two substitutions on that carbon.

Multiolefin refers to any monomer having two or more double bonds. In a preferred embodiment, the multiolefin is any monomer comprising two conjugated double bonds such as a conjugated diene like isoprene.

Isobutylene based elastomer or polymer refers to elastomers or polymers comprising at least 70 mol % repeat units from isobutylene.

Hydrocarbon refers to molecules or segments of molecules containing primarily hydrogen and carbon atoms. In some embodiments, hydrocarbon also includes halogenated versions of hydrocarbons and versions containing heteroatoms as discussed in more detail below.

Alkyl refers to a paraffinic hydrocarbon group which may be derived from an alkane by dropping one or more hydrogens from the formula, such as, for example, a methyl group (CH₃), or an ethyl group (CH₃CH₂), etc.

Aryl refers to a hydrocarbon group that forms a ring structure characteristic of aromatic compounds such as, for example, benzene, naphthalene, phenanthrene, anthracene, etc., and typically possess alternate double bonding (“unsaturation”) within its structure. An aryl group is thus a group derived from an aromatic compound by dropping one or more hydrogens from the formula such as, for example, a phenyl group (C₆H₅).

Substituted refers to at least one hydrogen group being replaced by at least one substituent selected from, for example, halogen (chlorine, bromine, fluorine, or iodine), amino, nitro, sulfoxy (sulfonate or alkyl sulfonate), thiol, alkylthiol, and hydroxy; alkyl, straight or branched chain having 1 to 20 carbon atoms which includes methyl, ethyl, propyl, isopropyl, normal butyl, isobutyl, secondary butyl, tertiary butyl, etc.; alkoxy, straight or branched chain alkoxy having 1 to 20 carbon atoms, and includes, for example, methoxy, ethoxy, propoxy, isopropoxy, butoxy, isobutoxy, secondary butoxy, tertiary butoxy, pentyloxy, isopentyloxy, hexyloxy, heptyloxy, octyloxy, nonyloxy, and decyloxy; haloalkyl, which means straight or branched chain alkyl having 1 to 20 carbon atoms which is substituted by at least one halogen, and includes, for example, chloromethyl, bromomethyl, fluoromethyl, iodomethyl, 2-chloroethyl, 2-bromoethyl, 2-fluoroethyl, 3-chloropropyl, 3-bromopropyl, 3-fluoropropyl, 4-chlorobutyl, 4-fluorobutyl, dichloromethyl, dibromomethyl, difluoromethyl, diiodomethyl, 2,2-dichloroethyl, 2,2-dibromoethyl, 2,2-difluoroethyl, 3,3-dichloropropyl, 3,3-difluoropropyl, 4,4-dichlorobutyl, 4,4-dibromobutyl, 4,4-difluorobutyl, trichloromethyl, trifluoromethyl, 2,2,2-trifluoroethyl, 2,3,3-trifluoropropyl, 1,1,2,2-tetrafluoroethyl, and 2,2,3,3-tetrafluoropropyl. Thus, for example, a “substituted styrenic unit” includes p-methylstyrene, p-ethylstyrene, etc.

Butyl Rubber

Preferred elastomers useful in the practice of this invention include isobutylene-based homopolymers or copolymers. As stated above, an isobutylene based elastomer or a polymer refers to an elastomer or a polymer comprising at least 70 mol % repeat units from isobutylene. These polymers can be described as random copolymer of a C₄ to C₇ isomonoolefin derived unit, such as isobutylene derived unit, and at least one other polymerizable unit. The isobutylene-based copolymer may or may not be halogenated.

In one embodiment of the invention, the elastomer is a butyl-type rubber or branched butyl-type rubber, especially halogenated versions of these elastomers. Useful elastomers are unsaturated butyl rubbers such as homopolymers and copolymers of olefins or isoolefins and multiolefins, or homopolymers of multiolefins. These and other types of elastomers suitable for the invention are well known and are described in RUBBER TECHNOLOGY, P 209-581 (Morton ed., Chapman & Hall 1995), THE VANDERBILT RUBBER HANDBOOK, P 105-122 (Ohm ed., R.T. Vanderbilt Co., Inc. 1990), and Kresge and Wang in 8 KIRK-OTHMER ENCYCLOPEDIA OF CHEMICAL TECHNOLOGY, P 934-955 (John Wiley & Sons, Inc. 4th ed. 1993). Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer.

Elastomeric compositions may comprise at least one butyl rubber. Butyl rubbers are prepared by reacting a mixture of monomers, the mixture having at least (1) a C₄ to C₇ isoolefin monomer component such as isobutylene with (2) a multiolefin, monomer component. The isoolefin is in a range from 70 to 99.5 wt % by weight of the total monomer mixture in one embodiment, and 85 to 99.5 wt % in another embodiment. The multiolefin component is present in the monomer mixture from 30 to 0.5 wt % in one embodiment, and from 15 to 0.5 wt % in another embodiment. In yet another embodiment, from 8 to 0.5 wt % of the monomer mixture is multiolefin.

The isoolefin is a C₄ to C₇ compound, non-limiting examples of which are compounds such as isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene, and other monomers such as disclosed in EP 0 279 456, U.S. Pat. No. 5,506,316 and U.S. Pat. No. 5,162,425. Other polymerizable monomers such as styrene and dichlorostyrene are also suitable for homopolymerization or copolymerization in butyl rubbers. One embodiment of the butyl rubber polymer of the invention is obtained by reacting 95 to 99.5 wt % of isobutylene with 0.5 to 8 wt % isoprene, or from 0.5 wt % to 5.0 wt % isoprene in yet another embodiment. Butyl rubbers and methods of their production are described in detail in, for example, U.S. Pat. No. 2,356,128, U.S. Pat. No. 3,968,076, U.S. Pat. No. 4,474,924, U.S. Pat. No. 4,068,051 and U.S. Pat. No. 5,532,312. See, also, WO 2004/058828, WO 2004/058827, WO 2004/058835, WO 2004/058836, WO 2004/058825, WO 2004/067577, and WO 2004/058829.

A commercial example of a desirable butyl rubber is EXXON™ BUTYL Grades of poly(isobutylene-co-isoprene), having a Mooney viscosity of from 30 to 56 (ML 1+8 at 125° C.) (ExxonMobil Chemical Company, Houston, Tex.). Another commercial example of a desirable butyl-type rubber is VISTANEX™ polyisobutylene rubber having a molecular weight viscosity average of from 0.75 to 2.34×10⁶ (ExxonMobil Chemical Company, Houston, Tex.).

Branched Butyl Rubber

Another embodiment of the butyl rubber useful in the invention is a branched or “star-branched” butyl rubber. These rubbers are described in, for example, EP 0 678 529 B1, U.S. Pat. No. 5,182,333 and U.S. Pat. No. 5,071,913. In one embodiment, the star-branched butyl rubber (“SBB”) is a composition of a butyl rubber, either halogenated or not, and a polydiene or block copolymer, either halogenated or not. The invention is not limited by the method of forming the SBB. The polydienes/block copolymer, or branching agents (hereinafter “polydienes”), are typically cationically reactive and are present during the polymerization of the butyl or halogenated butyl rubber, or can be blended with the butyl rubber to form the SBB. The branching agent or polydiene can be any suitable branching agent, and the invention is not limited to the type of polydiene used to make the SBB.

In one embodiment, the SBB is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber (EPDM), ethylene-propylene rubber (EPR), styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the SBB of the present invention is SB Butyl 4266 (ExxonMobil Chemical Company, Houston, Tex.), having a Mooney viscosity (ML 1+8 at 125° C., ASTM D 1646) of from 34 to 44. Further, cure characteristics of SB Butyl 4266 are as follows: MH is 69±6 dN·m, ML is 11.5±4.5 dN·m (ASTM D2084).

Halogenated Butyl Rubber

The elastomer in a desirable embodiment of the invention is halogenated. Halogenated butyl rubber is produced by the halogenation of the butyl rubber product described above. Halogenation can be carried out by any means, and the invention is not herein limited by the halogenation process. Methods of halogenating polymers such as butyl polymers are disclosed in U.S. Pat. No. 2,631,984, U.S. Pat. No. 3,099,644, U.S. Pat. No. 4,554,326, U.S. Pat. No. 4,681,921, U.S. Pat. No. 4,650,831, U.S. Pat. No. 4,384,072, U.S. Pat. No. 4,513,116 and U.S. Pat. No. 5,681,901. In one embodiment, the butyl rubber is halogenated in hexane diluent at from 4 to 60° C. using bromine (Br₂) or chlorine (Cl₂) as the halogenation agent. The halogenated butyl rubber has a Mooney Viscosity of from 20 to 70 (ML 1+8 at 125° C.) in one embodiment, and from 25 to 55 in another embodiment. The halogen wt % is from 0.1 to 10 wt % based in on the weight of the halogenated butyl rubber in one embodiment, and from 0.5 to 5 wt % in another embodiment. In yet another embodiment, the halogen wt % of the halogenated butyl rubber is from 1 to 2.5 wt %.

A commercial embodiment of a suitable halogenated butyl rubber of the present invention is Bromobutyl 2222 (ExxonMobil Chemical Company, Houston, Tex.). Its Mooney viscosity is from 27 to 37 (ML 1+8 at 125° C., ASTM 1646, modified), and the bromine content is from 1.8 to 2.2 wt % relative to the Bromobutyl 2222. Further, cure characteristics of Bromobutyl 2222 are as follows: MH is from 28 to 40 dN·m, ML is from 7 to 18 dN·m (ASTM D2084). Another commercial embodiment of the halogenated butyl rubber is Bromobutyl 2255 (ExxonMobil Chemical Company, Houston, Tex.). Its Mooney viscosity is from 41 to 51 (ML 1+8 at 125° C., ASTM D1646), and the bromine content is from 1.8 to 2.2 wt %. Further, cure characteristics of Bromobutyl 2255 are as follows: MH is from 34 to 48 dN·m, ML is from 11 to 21 dN·m (ASTM D2084).

Branched Halogenated Butyl Rubber

In another embodiment of elastomer of the invention, a branched or “star-branched” halogenated butyl rubber is used. In one embodiment, the halogenated star-branched butyl rubber is a composition of a butyl rubber, either halogenated or not, and a polydiene or block copolymer, either halogenated or not. The halogenation process is described in detail in U.S. Pat. No. 4,074,035, U.S. Pat. No. 5,071,913, U.S. Pat. No. 5,286,804, U.S. Pat. No. 5,182,333 and U.S. Pat. No. 6,228,978. The invention is not limited by the method of forming the halogenated star branched butyl rubber. The polydienes/block copolymer, or branching agents (hereinafter “polydienes”), are typically cationically reactive and are present during the polymerization of the butyl or halogenated butyl rubber, or can be blended with the butyl or halogenated butyl rubber to form the halogenated star branched butyl rubber. The branching agent or polydiene can be any suitable branching agent, and the invention is not limited to the type of polydiene used to make the halogenated star branched butyl rubber.

In one embodiment, the halogenated star branched butyl rubber is typically a composition of the butyl or halogenated butyl rubber as described above and a copolymer of a polydiene and a partially hydrogenated polydiene selected from the group including styrene, polybutadiene, polyisoprene, polypiperylene, natural rubber, styrene-butadiene rubber, ethylene-propylene diene rubber, styrene-butadiene-styrene and styrene-isoprene-styrene block copolymers. These polydienes are present, based on the monomer wt %, greater than 0.3 wt % in one embodiment, and from 0.3 to 3 wt % in another embodiment, and from 0.4 to 2.7 wt % in yet another embodiment.

A commercial embodiment of the halogenated star branched butyl rubber of the present invention is Bromobutyl 6222 (ExxonMobil Chemical Company, Houston, Tex.), having a Mooney viscosity (ML 1+8 at 125° C., ASTM D1646) of from 27 to 37, and a bromine content of from 2.2 to 2.6 wt % relative to the halogenated star branched butyl rubber. Further, cure characteristics of Bromobutyl 6222 are as follows: MH is from 24 to 38 dN·m, ML is from 6 to 16 dN·m (ASTM D2084).

Halogenated Isobutylene-para-Methylstyrene Rubber

Elastomeric compositions of the present invention may also comprise at least one random copolymer comprising a C₄ to C₇ isomonoolefins, such as isobutylene and an alkylstyrene comonomer, such as para-methylstyrene, containing at least 80%, more alternatively at least 90% by weight of the para-isomer and optionally include functionalized interpolymers wherein at least one or more of the alkyl substituents groups present in the styrene monomer units contain benzylic halogen or some other functional group. In another embodiment, the polymer may be a random elastomeric copolymer of ethylene or a C₃ to C₆ α-olefin and an alkylstyrene comonomer, such as para-methylstyrene containing at least 80%, alternatively at least 90% by weight of the para-isomer and optionally include functionalized interpolymers wherein at least one or more of the alkyl substituents groups present in the styrene monomer units contain benzylic halogen or some other functional group. Exemplary materials may be characterized as polymers containing the following monomer units randomly spaced along the polymer chain: 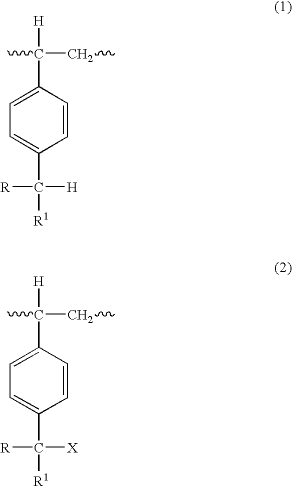
wherein R and R¹ are independently hydrogen, lower alkyl, such as a C₁ to C₇ alkyl and primary or secondary alkyl halides and X is a functional group such as halogen. In an embodiment, R and R¹ are each hydrogen. Up to 60 mol % of the para-substituted styrene present in the random polymer structure may be the functionalized structure (2) above in one embodiment, and in another embodiment from 0.1 to 5 mol %. In yet another embodiment, the amount of functionalized structure (2) is from 0.2 to 3 mol %.

The functional group X may be halogen or some other functional group which may be incorporated by nucleophilic substitution of benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. These functionalized isomonoolefin copolymers, their method of preparation, methods of functionalization, and cure are more particularly disclosed in U.S. Pat. No. 5,162,445.

In an embodiment, the elastomer comprises random polymers of isobutylene and para-methylstyrene containing from 0.5 to 20 mol % para-methylstyrene wherein up to 60 mol % of the methyl substituent groups present on the benzyl ring contain a bromine or chlorine atom, such as a bromine atom (para-(bromomethylstyrene)), as well as acid or ester functionalized versions thereof.

In another embodiment, the functionality is selected such that it can react or form polar bonds with functional groups present in the matrix polymer, for example, acid, amino or hydroxyl functional groups, when the polymer components are mixed at high temperatures.

In certain embodiments, the random copolymers have a substantially homogeneous compositional distribution such that at least 95 wt % of the polymer has a para-alkylstyrene content within 10% of the average para-alkylstyrene content of the polymer. Exemplary polymers are characterized by a narrow molecular weight distribution (Mw/Mn) of less than 5, alternatively less than 2.5, an exemplary viscosity average molecular weight in the range of from 200,000 up to 2,000,000 and an exemplary number average molecular weight in the range of from 25,000 to 750,000 as determined by gel permeation chromatography.

The elastomer such as the random copolymer discussed above may be prepared by a slurry polymerization, typically in a diluent comprising a halogenated hydrocarbon(s) such as a chlorinated hydrocarbon and/or a fluorinated hydrocarbon including mixtures thereof, (see e.g., WO 2004/058828, WO 2004/058827, WO 2004/058835, WO 2004/058836, WO 2004/058825, WO 2004/067577, and WO 2004/058829), of the monomer mixture using a Lewis acid catalyst, followed by halogenation, preferably bromination, in solution in the presence of halogen and a radical initiator such as heat and/or light and/or a chemical initiator and, optionally, followed by electrophilic substitution of bromine with a different functional moiety.

In an embodiment, brominated poly(isobutylene-co-p-methylstyrene) polymers generally contain from 0.1 to 5 mol % of bromomethylstyrene groups relative to the total amount of monomer derived units in the copolymer. In another embodiment, the amount of bromomethyl groups is from 0.2 to 3.0 mol %, and from 0.3 to 2.8 mol % in yet another embodiment, and from 0.4 to 2.5 mol % in yet another embodiment, and from 0.3 to 2.0 mol % in yet another embodiment, wherein a desirable range may be any combination of any upper limit with any lower limit. Expressed another way, exemplary copolymers contain from 0.2 to 10 wt % of bromine, based on the weight of the polymer, from 0.4 to 6 wt % bromine in another embodiment, and from 0.6 to 5.6 wt % in another embodiment, are substantially free of ring halogen or halogen in the polymer backbone chain. In one embodiment, the random polymer is a copolymer of C₄ to C₇ isoolefin derived units (or isomonoolefin), para-methylstyrene derived units and para-(halomethylstyrene) derived units, wherein the para-(halomethylstyrene) units are present in the polymer from 0.4 to 3.0 mol % based on the total number of para-methylstyrene, and wherein the para-methylstyrene derived units are present from 3 to 15 wt % based on the total weight of the polymer in one embodiment, and from 4 to 10 wt % in another embodiment. In another embodiment, the para-(halomethylstyrene) is para-(bromomethylstyrene).

A commercial embodiment of the halogenated isobutylene-p-methylstyrene rubber of the present invention is EXXPRO™ elastomers (ExxonMobil Chemical Company, Houston, Tex.), having a Mooney viscosity (ML 1+8 at 125° C., ASTM D1646) of from 30 to 50, a p-methylstyrene content of from 4 to 8.5 wt %, and a bromine content of from 0.7 to 2.2 wt % relative to the halogenated isobutylene-p-methylstyrene rubber.

In certain embodiments directed to blends, the elastomer(s) as described above may be combined with at least one “general purpose rubber.”

General Purpose Rubber

A general purpose rubber, often referred to as a commodity rubber, may be any rubber that usually provides high strength and good abrasion along with low hysteresis and high resilience. These elastomers require antidegradants in the mixed compound because they generally have poor resistance to both heat and oxygen, in particular to ozone. They are often easily recognized in the market because of their low selling prices relative to specialty elastomers and their big volumes of usage as described by School in RUBBER TECHNOLOGY COMPOUNDING AND TESTING FOR PERFORMANCE, p 125 (Dick, ed., Hanser, 2001).

Examples of general purpose rubbers include natural rubbers (NR), polyisoprene rubber (IR), poly(styrene-co-butadiene) rubber (SBR), polybutadiene rubber (BR), poly(isoprene-co-butadiene) rubber (IBR), and styrene-isoprene-butadiene rubber (SIBR), and mixtures thereof. Ethylene-propylene rubber (EPM) and ethylene-propylene-diene rubber (EPDM), and their mixtures, often are also referred to as general purpose elastomers.

In another embodiment, the composition may also comprise a natural rubber. Natural rubbers are described in detail by Subramaniam in RUBBER TECHNOLOGY, p 179-208 (Morton, ed., Chapman & Hall, 1995). Desirable embodiments of the natural rubbers of the present invention are selected from Malaysian rubber such as SMR CV, SMR 5, SMR 10, SMR 20, and SMR 50 and mixtures thereof, wherein the natural rubbers have a Mooney viscosity as measured at 100° C. (ML 1+4) of from 30 to 120, more preferably from 40 to 65. The Mooney viscosity test referred to herein is in accordance with ASTM D1646.

In another embodiment, the elastomeric composition may also comprise a polybutadiene rubber (BR). The Mooney viscosity of the polybutadiene rubber as measured at 100° C. (ML 1+4) may range from 35 to 70, from 40 to about 65 in another embodiment, and from 45 to 60 in yet another embodiment. Commercial examples of these synthetic rubbers useful in the present invention are sold under the trade name BUDENE™ (Goodyear Chemical Company, Akron, Ohio), BUNA™ (Lanxess Inc., Sarnia, Ontario, Canada), and Diene™ (Firestone Polymers LLC, Akron, Ohio). An example is high cis-polybutadiene (cis-BR). By “cis-polybutadiene” or “high cis-polybutadiene”, it is meant that 1,4-cis polybutadiene is used, wherein the amount of cis component is at least 95%. A particular example of high cis-polybutadiene commercial products used in the composition BUDENE™ 1207 or BUNA™ CB 23.

In another embodiment, the elastomeric composition may also comprise a polyisoprene rubber (IR). The Mooney viscosity of the polyisoprene rubber as measured at 100° C. (ML 1+4) may range from 35 to 70, from 40 to about 65 in another embodiment, and from 45 to 60 in yet another embodiment. A commercial example of these synthetic rubbers useful in the present invention is NATSYN™ 2200 (Goodyear Chemical Company, Akron, Ohio).

In another embodiment, the elastomeric composition may also comprise rubbers of ethylene and propylene derived units such as EPM and EPDM as suitable additional rubbers. Examples of suitable comonomers in making EPDM are ethylidene norbornene, 1,4-hexadiene, dicyclopentadiene, as well as others. These rubbers are described in RUBBER TECHNOLOGY, P 260-283 (1995). A suitable ethylene-propylene rubber is commercially available as VISTALON™ (ExxonMobil Chemical Company, Houston, Tex.).

In yet another embodiment, the elastomeric composition may comprise a terpolymer of ethylene/alpha-olefin/diene terpolymer. The alpha-olefin is selected from the group consisting of C₃ to C₂₀ alpha-olefin with propylene, butene and octene preferred and propylene most preferred. The diene component is selected from the group consisting of C₄ to C₂₀ dienes. Examples of suitable dienes include straight chain, hydrocarbon diolefin or cylcloalkenyl-substituted alkenes having from 6 to 15 carbon atoms. Specific examples include (a) straight chain acyclic dienes such as 1,4-hexadiene and 1,6-octadiene; (b) branched chain acyclic dienes such as 5-methyl-1,4-hexadiene; 3,7-dimethyl-1,6-octadiene; 3,7-dimethyl-1,7-octadiene; and the mixed isomers of dihydromyricene and dihydroocinene; (c) single ring alicyclic dienes, such as 1,3 cyclopentadiene; 1,4-cyclohexadiene; 1,5-cyclooctadiene and 1,5-cyclododecadiene; (d) multi-ring alicyclic fused and bridged ring dienes such as tetrahydroindene; methyl-tetrahydroindene; dicyclopentadiene (DCPD); bicyclo-(2.2.1)-hepta-2,5-diene; alkenyl, alkylidene, cycloalkenyl and cycloalkylidene norbornene, such as 5-methylene-2-norbornene (MNB), 5-propenyl-2-norbornene, 5-isopropylidene-2-norbornene, 5-ethylidene-2-norbornene (ENB), 5-(4-cyclopentenyl)-2-norbornene, 5-cyclohexylidene-2-norbornene, and 5-vinyl-2-norbornene (VNB); (e) cycloalkenyl-substituted alkenes, such as allyl cyclohexene, vinyl cyclooctene, allyl cyclodecene, vinyl cyclododecene. Examples also include dicyclopentadiene, 1,4-hexadiene, 5-methylene-2-norbornene, and 5-ethylidene-2-norbornene. Examples of diolefins are 5-ethylidene-2-norbornene; 1,4-hexadiene, dicyclopentadiene and 5-vinyl-2-norbornene. For more information and an example how an artisan might apply these terpolymer, see, for example, U.S. Pat. No. 6,245,856.

Specialty Rubber

In one embodiment, the secondary elastomer is a specialty rubber containing a polar functional group such as butadiene-acrylonitrile rubber (NBR, or nitrile rubber), a copolymer of 2-propenenitrile and 1,3-butadiene. Nitrile rubber can have an acrylonitrile content of from 10 to 50 wt % in one embodiment, from 15 to 40 wt % in another embodiment, and from 18 to 35 wt % in yet another embodiment. The Mooney viscosity may range from 30 to 90 in one embodiment (1+4, 100° C., ASTM D1646), and from 30 to 75 in another embodiment. These rubbers are common in the art, and described in, for example, HANDBOOK OF PLASTICS, ELASTOMERS, AND COMPOSITES 1.41-1.49 (Harper, ed., McGraw-Hill, Inc. 1992). Commercial examples of these synthetic rubbers useful in the present invention are sold under the trade names BREON™, NIPOL™, SIVIC™ and ZETPOL™ (Zeon Chemicals, Louisville, Ky.), EUROPRENE™ N (Polimeri Europa Americas, Houston, Tex.), and KRYNAC™, PERBUNAN™ and THERBAN™ (Lanxess Corporation, Akron, Ohio).

In another embodiment, the secondary elastomer is a derivative of NBR such as hydrogenated or carboxylated or styrenated nitrile rubbers. Butadiene-acrylonitrile-styrene rubber (SNBR, or “ABS” rubber), a copolymer of 2-propenenitrile, 1,3-butadiene and styrene, can have an acrylonitrile content of from 10 to 40 wt % in one embodiment, from 15 to 30 wt % in another embodiment, and from 18 to 30 wt % in yet another embodiment. The styrene content of the SNBR copolymer may range from 15 to 40 wt % in one embodiment, and from 18 to 30 wt % in another embodiment, and from 20 to 25 wt % in yet another embodiment. The Mooney viscosity may range from 30 to 60 in one embodiment (1+4, 100° C., ASTM D1646), and from 30 to 55 in another embodiment. These rubbers are common in the art, and described in, for example, HANDBOOK OF PLASTICS, ELASTOMERS, AND COMPOSITES 1.41-1.49 (Harper, ed., McGraw-Hill, Inc. 1992). A commercial example of this synthetic rubber useful in the present invention is sold under the trade name KRYNAC™ (Lanxess Corporation, Akron, Ohio).

In yet another embodiment, the secondary elastomer is a specialty rubber containing a halogen group such as polychloroprene (CR, or chloroprene rubber), a homopolymer of 2-chloro-1,3-butadiene. The Mooney viscosity may range from 30 to 110 in one embodiment (1+4, 100° C., ASTM D1646), and from 35 to 75 in another embodiment. These rubbers are common in the art, and described in, for example, HANDBOOK OF PLASTICS, ELASTOMERS, AND COMPOSITES 1.41-1.49 (Harper, ed., McGraw-Hill, Inc. 1992). Commercial examples of these synthetic rubbers useful in the present invention are sold under the trade names NEOPRENE™ (DuPont Dow Elastomers, Wilmington, Del.), BUTACLOR™ (Polimeri Europa Americas, Houston, Tex.) and BAYPREN™ (Lanxess Corporation, Akron, Ohio).

Semicrystalline Polymer

In an embodiment, the elastomeric compositions may comprise at least one semicrystalline polymer that is an elastic polymer with a moderate level of crystallinity due to stereoregular propylene sequences. The semicrystalline polymer may comprise: (A) a propylene homopolymer in which the stereoregularity is disrupted in some manner such as by regio-inversions; (B) a random propylene copolymer in which the propylene stereoregularity is disrupted at least in part by comonomers or (C) a combination of (A) and (B).

In another embodiment, the semicrystalline polymer further comprises a non-conjugated diene monomer to aid in vulcanization and other chemical modification of the blend composition. The amount of diene present in the polymer is preferably less than 10 wt %, and more preferably less than 5 wt %. The diene may be any non-conjugated diene which is commonly used for the vulcanization of ethylene propylene rubbers including, but not limited to, ethylidene norbornene, vinyl norbornene, and dicyclopentadiene.

In one embodiment, the semicrystalline polymer is a random copolymer of propylene and at least one comonomer selected from ethylene, C₄-C₁₂ α-olefins, and combinations thereof. In a particular aspect of this embodiment, the copolymer includes ethylene-derived units in an amount ranging from a lower limit of 2 wt %, 5 wt %, 6 wt %, 8 wt %, or 10 wt % to an upper limit of 20 wt %, 25 wt %, or 28 wt %. This embodiment may also include propylene-derived units present in the copolymer in an amount ranging from a lower limit of 72 wt %, 75 wt %, or 80 wt % to an upper limit of 98 wt %, 95 wt %, 94 wt %, 92 wt %, or 90 wt %. These percentages by weight are based on the total weight of the propylene and ethylene-derived units; i.e., based on the sum of weight percent propylene-derived units and weight percent ethylene-derived units being 100%.

The ethylene composition of a polymer can be measured as follows. A thin homogeneous film is pressed at a temperature of about 150° C. or greater, then mounted on a Perkin Elmer PE 1760 infrared spectrophotometer. A full spectrum of the sample from 600 cm⁻¹ to 4000 cm⁻¹ is recorded and the monomer weight percent of ethylene can be calculated according to the following equation: Ethylene wt %=82.585−111.987X+30.045 X², wherein X is the ratio of the peak height at 1155 cm⁻¹ and peak height at either 722 cm⁻¹ or 732 cm⁻¹, whichever is higher. The concentrations of other monomers in the polymer can also be measured using this method.

Comonomer content of discrete molecular weight ranges can be measured by Fourier Transform Infrared Spectroscopy (FTIR) in conjunction with samples collected by GPC. One such method is described in Wheeler and Willis, Applied Spectroscopy, vol 47, p 1128-1130 (1993). Different but similar methods are equally functional for this purpose and well known to those skilled in the art.

Comonomer content and sequence distribution of the polymers can be measured by ¹³C nuclear magnetic resonance spectroscopy (¹³C NMR), and such method is well known to those skilled in the art.

In one embodiment, the semicrystalline polymer comprises a random propylene copolymer having a narrow compositional distribution. In another embodiment, the polymer is a random propylene copolymer having a narrow compositional distribution and a melting point as determined by DSC of from 25° C. to 110° C. The copolymer is described as random because for a polymer comprising propylene, comonomer, and optionally diene, the number and distribution of comonomer residues is consistent with the random statistical polymerization of the monomers. In stereoblock structures, the number of block monomer residues of any one kind adjacent to one another is greater than predicted from a statistical distribution in random copolymers with a similar composition. Historical ethylene-propylene copolymers with stereoblock structure have a distribution of ethylene residues consistent with these blocky structures rather than a random statistical distribution of the monomer residues in the polymer. The intramolecular composition distribution (i.e., randomness) of the copolymer may be determined by ¹³C NMR, which locates the comonomer residues in relation to the neighboring propylene residues. The intermolecular composition distribution of the copolymer is determined by thermal fractionation in a solvent. A typical solvent is a saturated hydrocarbon such as hexane or heptane. The thermal fractionation procedure is described below. Typically, approximately 75 wt %, preferably 85 wt %, of the copolymer is isolated as one or two adjacent, soluble fractions with the balance of the copolymer in immediately preceding or succeeding fractions. Each of these fractions has a composition (wt % comonomer such as ethylene or other α-olefin) with a difference of no greater than 20% (relative), preferably 10% (relative), of the average weight % comonomer of the copolymer. The copolymer has a narrow compositional distribution if it meets the fractionation test described above. To produce a copolymer having the desired randomness and narrow composition, it is beneficial if (1) a single sited metallocene catalyst is used which allows only a single statistical mode of addition of the first and second monomer sequences and (2) the copolymer is well-mixed in a continuous flow stirred tank polymerization reactor which allows only a single polymerization environment for substantially all of the polymer chains of the copolymer.

The crystallinity of the polymers may be expressed in terms of heat of fusion. Embodiments of the present invention include polymers having a heat of fusion, as determined by DSC, ranging from a lower limit of 1.0 J/g, or 3.0 J/g, to an upper limit of 50 J/g, or 10 J/g. Without wishing to be bound by theory, it is believed that the polymers of embodiments of the present invention have generally isotactic crystallizable propylene sequences, and the above heats of fusion are believed to be due to the melting of these crystalline segments.

The crystallinity of the polymer may also be expressed in terms of crystallinity percent. The thermal energy for the highest order of polypropylene is estimated at 189 J/g. That is, 100% crystallinity is equal to 189 J/g. Therefore, according to the aforementioned heats of fusion, the polymer has a polypropylene crystallinity within the range having an upper limit of 65%, 40%, 30%, 25%, or 20%, and a lower limit of 1%, 3%, 5%, 7%, or 8%.

The level of crystallinity is also reflected in the melting point. The term “melting point,” as used herein, is the highest peak among principal and secondary melting peaks as determined by DSC, discussed above. In one embodiment of the present invention, the polymer has a single melting point. Typically, a sample of propylene copolymer will show secondary melting peaks adjacent to the principal peak, which are considered together as a single melting point. The highest of these peaks is considered the melting point. The polymer preferably has a melting point by DSC ranging from an upper limit of 110° C., 100° C., 90° C., 80° C., or 70° C., to a lower limit of 0° C., 20° C., 25° C., 30° C., 35° C., 40° C., or 45° C. Typically, a sample of the alpha-olefin copolymer component will show secondary melting peaks adjacent to principal peak; these are considered together as single melting point. The highest of the peaks is considered the melting point.

The semicrystalline polymer may have a weight average molecular weight (Mw) within the range having an upper limit of 5,000,000 g/mol, 1,000,000 g/mol, or 500,000 g/mol, and a lower limit of 10,000 g/mol, 20,000 g/mol, or 80,000 g/mol, and a molecular weight distribution Mw/Mn (MWD), sometimes referred to as a “polydispersity index” (PDI), ranging from a lower limit of 1.5, 1.8, or 2.0 to an upper limit of 40, 20, 10, 5, or 4.5. The Mw and MWD, as used herein, can be determined by a variety of methods, including those in U.S. Pat. No. 4,540,753 and references cited therein, or those methods found in Verstrate et al., Macromolecules, vol 21, p 3360 (1988), the descriptions of which are incorporated by reference herein for purposes of United States practices.

In one embodiment, the semicrystalline polymer has a Mooney viscosity, ML(1+4) @ 125° C., of 100 or less, 75 or less, 60 or less, or 30 or less. Mooney viscosity, as used herein, can be measured as ML(1+4) @ 125° C. according to ASTM D1646.

In embodiments of the present invention, the semicrystalline polymer has a melt flow rate (MFR) of 5000 dg/min or less, alternatively, 300 dg/min or less, alternatively 200 dg/min or less, alternatively, 100 dg/min or less, alternatively, 50 dg/min or less, alternatively, 20 dg/min or less, alternatively, 10 dg/min or less, or, alternatively, 2 dg/min or less. The determination of the MFR of the polymer is according to ASTM D1238 (230° C., 2.16 kg).

In certain embodiments, the semicrystalline polymer of the present invention is present in the inventive blend compositions in an amount ranging from a lower limit of 50 wt %, 70 wt %, 75 wt %, 80 wt %, 82 wt %, or 85 wt % based on the total weight of the composition, to an upper limit of 99 wt %, 95 wt %, or 90 wt % based on the total weight of the composition.

In certain embodiments, the semicrystalline polymer used in the present invention is described, for example, in WO 00/69963, WO 00/01766, WO 99/07788, WO 02/083753, and described in further detail as the “Propylene Olefin Copolymer” in WO 00/01745. Semicrystalline polymers are commercially available as VISTAMAXX™ specialty elastomers (ExxonMobil Chemical Company, Houston, Tex.) and VERSIFY™ elastomers (not produced from processes herein described) (Dow Chemical Company, Midland, Mich.).

Thermoplastic Resin

In another embodiment, the elastomeric compositions may comprise at least one thermoplastic resin. Thermoplastic resins suitable for practice of the present invention may be used singly or in combination and are resins containing nitrogen, oxygen, halogen, sulfur or other groups capable of interacting with an aromatic functional groups such as halogen or acidic groups. The resins are present in the nanocomposite from 30 to 90 wt % of the nanocomposite in one embodiment, and from 40 to 80 wt % in another embodiment, and from 50 to 70 wt % in yet another embodiment. In yet another embodiment, the resin is present at a level of greater than 40 wt % of the nanocomposite, and greater than 60 wt % in another embodiment.

Suitable thermoplastic resins include resins selected from the group consisting or polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK) and mixtures thereof.

Suitable thermoplastic polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines. Both fiber-forming and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethyleneisophthalamide (nylon-6, IP) and the condensation product of 11-amino-undecanoic acid (nylon-11). Additional examples of satisfactory polyamides (especially those having a softening point below 275° C.) are described in 16 ENCYCLOPEDIA OF CHEMICAL TECHNOLOGY, P 1-105 (John Wiley & Sons 1968), CONCISE ENCYCLOPEDIA OF POLYMER SCIENCE AND Technology, p 748-761 (John Wiley & Sons, 1990), and 10 ENCYCLOPEDIA OF POLYMER SCIENCE AND TECHNOLOGY, p 392-414 (John Wiley & Sons 1969). Commercially available thermoplastic polyamides may be advantageously used in the practice of this invention, with linear crystalline polyamides having a softening point or melting point between 160° C. and 260° C. being preferred.

Suitable thermoplastic polyesters which may be employed include the polymer reaction products of one or a mixture of aliphatic or aromatic polycarboxylic acids esters of anhydrides and one or a mixture of diols. Examples of satisfactory polyesters include poly(trans-1,4-cyclohexylene C₂₋₆ alkane dicarboxylates such as poly(trans-1,4-cyclohexylene succinate) and poly(trans-1,4-cyclohexylene adipate); poly(cis or trans-1,4-cyclohexanedimethylene) alkanedicarboxylates such as poly(cis-1,4-cyclohexanedimethylene)oxlate and poly-(cis-1,4-cyclohexanedimethylene)succinate, poly(C₂₋₄ alkylene terephthalates) such as polyethyleneterephthalate and polytetramethylene-terephthalate, poly(C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C2 to C₄ diols, such as polyethylene terephthalate and polybutylene terephthalate. Preferred polyesters will have a melting point in the range of 160° C. to 260° C.

Poly(phenylene ether) (PPE) thermoplastic resins which may be used in accordance with this invention are well known, commercially available materials produced by the oxidative coupling polymerization of alkyl substituted phenols. They are generally linear, amorphous polymers having a glass transition temperature in the range of 190° C. to 235° C. These polymers, their method of preparation and compositions with polystyrene are further described in U.S. Pat. No. 3,383,435.

Other thermoplastic resins which may be used include the polycarbonate analogs of the polyesters described above such as segmented poly (ether co-phthalates); polycaprolactone polymers; styrene resins such as copolymers of styrene with less than 50 mol % of acrylonitrile (SAN) and resinous copolymers of styrene, acrylonitrile and butadiene (ABS); sulfone polymers such as polyphenyl sulfone; copolymers and homopolymers of ethylene and C₂ to C₈ α-olefins, in one embodiment a homopolymer of propylene derived units, and in another embodiment a random copolymer or block copolymer of ethylene derived units and propylene derived units, and like thermoplastic resins as are known in the art.

In another embodiment the compositions of this invention further comprising any of the thermoplastic resins (also referred to as a thermoplastic or a thermoplastic polymer) described above are formed into dynamically vulcanized alloys.

The term “dynamic vulcanization” is used herein to connote a vulcanization process in which the engineering resin and a vulcanizable elastomer are vulcanized under conditions of high shear. As a result, the vulcanizable elastomer is simultaneously crosslinked and dispersed as fine particles of a “micro gel” within the engineering resin matrix.

Dynamic vulcanization is effected by mixing the ingredients at a temperature which is at or above the curing temperature of the elastomer in equipment such as roll mills, Banbury™, mixers, continuous mixers, kneaders or mixing extruders, e.g., twin screw extruders. The unique characteristic of the dynamically cured compositions is that, notwithstanding the fact that the elastomer component may be fully cured, the compositions can be processed and reprocessed by conventional rubber processing techniques such as extrusion, injection molding, compression molding, etc. Scrap or flashing can be salvaged and reprocessed.

Particularly preferred thermoplastic polymers useful in DVA's of this invention include engineering resins selected from the group consisting of polyamides, polycarbonates, polyesters, polysulfones, polylactones, polyacetals, acrylonitrile-butadiene-styrene resins (ABS), polyphenyleneoxide (PPO), polyphenylene sulfide (PPS), styrene-acrylonitrile resins (SAN), polyimides, styrene maleic anhydride (SMA), aromatic polyketones (PEEK, PEK, and PEKK) and mixtures thereof. Preferred engineering resins are polyamides. The more preferred polyamides are nylon 6 and nylon 11. Preferably the engineering resin(s) may suitably be present in an amount ranging from about 10 to 98 wt %, preferably from about 20 to 95 wt %, the elastomer may be present in an amount ranging from about 2 to 90 wt %, preferably from about 5 to 80 wt %, based on the polymer blend. Preferably the elastomer is present in said composition as particles dispersed in said engineering resin.

In a preferred embodiment the elastomer is selected from poly(isobutylene-co-alkylstyrene), preferably poly(isobutylene-co-p-methylstyrene), halogenated poly(isobutylene-co-alkylstyrene), preferably halogenated poly(isobutylene-co-p-methylstyrene), star branched butyl rubber, halogenated star-branched butyl rubber, butyl rubber, halogenated butyl rubber, and mixtures thereof. In another preferred embodiment the elastomer comprises bromobutyl rubber and or chlorobutyl rubber.

The elastomer may be present in the elastomeric composition in a range from up to 90 phr in one embodiment, from up to 50 phr in another embodiment, from up to 40 phr in another embodiment, and from up to 30 phr in yet another embodiment. In yet another embodiment, the elastomer may be present from at least 2 phr, and from at least 5 phr in another embodiment, and from at least 5 phr in yet another embodiment, and from at least 10 phr in yet another embodiment. A desirable embodiment may include any combination of any upper phr limit and any lower phr limit.

In other embodiments, the elastomer, either individually or as a blend (i.e., reactor blends, physical blends such as by melt mixing) of elastomers may be present in the composition from 5 to 90 phr in one embodiment, and from 10 to 80 phr in another embodiment, and from 30 to 70 phr in yet another embodiment, and from 40 to 60 phr in yet another embodiment, and from 5 to 50 phr in yet another embodiment, and from 5 to 40 phr in yet another embodiment, and from 20 to 60 phr in yet another embodiment, and from 20 to 50 phr in yet another embodiment, the chosen embodiment depending upon the desired end use application of the composition.

The elastomeric compositions may also contain at least one other elastomer or two or more elastomers. The elastomer(s) may also be combined with other materials or polymers.

In certain embodiments and where applicable, the elastomers used in the practice of the invention can be linear, substantially linear, blocky or branched.

The elastomeric compositions may also include a variety of other components and may be optionally cured to form cured elastomeric compositions that ultimately are fabricated into end use articles.

For example, the elastomeric compositions may optionally comprise:

a) at least one filler, for example, calcium carbonate, clay, mica, silica, silicates, talc, titanium dioxide, starch, wood flower, carbon black, or mixtures thereof;

b) at least one clay, for example, montmorillonite, nontronite, beidellite, volkonskoite, laponite, hectorite, saponite, sauconite, magadite, kenyaite, stevensite, vermiculite, halloysite, aluminate oxides, hydrotalcite, or mixtures thereof, optionally, treated with modifying agents;

c) at least one processing oil, for example, aromatic oil, naphthenic oil, paraffinic oil, or mixtures thereof;

d) at least one processing aid, for example, plastomer, polybutene, polyalphaolefin oils, or mixtures thereof;

e) at least one cure package or curative or wherein the composition has undergone at least one process to produce a cured composition;

f) any combination of a-e.

Processing Aids

Plastomers

The plastomers that are useful in the present invention can be described as polyolefin copolymers having a density of from 0.85 to 0.915 g/cm³ and a melt index (MI) between 0.10 and 30 dg/min. In one embodiment, the useful plastomer is a copolymer of ethylene derived units and at least one of C₃ to C₁₀ α-olefin derived units, the copolymer having a density in the range of less than 0.915 g/cm³. The amount of comonomer (C₃ to C₁₀ α-olefin derived units) present in the plastomer ranges from 2 to 35 wt % in one embodiment, and from 5 to 30 wt % in another embodiment, and from 15 to 25 wt % in yet another embodiment, and from 20 to 30 wt % in yet another embodiment.

The plastomer useful in the invention has a melt index (MI) of between 0.1 and 20 dg/min (ASTM D1238; 190° C., 2.1 kg) in one embodiment, and from 0.2 to 10 dg/min in another embodiment, and from 0.3 to 8 dg/min in yet another embodiment. The average molecular weight of useful plastomers ranges from 10,000 to 800,000 in one embodiment, and from 20,000 to 700,000 in another embodiment. The 1% secant flexural modulus (ASTM D790) of useful plastomers ranges from 10 MPa to 150 MPa in one embodiment, and from 20 MPa to 100 MPa in another embodiment. Further, the plastomer that is useful in compositions of the present invention has a melting temperature (Tm) of from 50° C. to 62° C. (first melt peak) and from 65° C. to 85° C. (second melt peak) in one embodiment, and from 52° C. to 60° C. (first melt peak) and from 70° C. to 80° C. (second melt peak) in another embodiment.

Plastomers useful in the present invention are metallocene catalyzed copolymers of ethylene derived units and higher α-olefin derived units such as propylene, 1-butene, 1-hexene and 1-octene, and which contain enough of one or more of these comonomer units to yield a density between 0.860 and 0.900 g/cm³ in one embodiment. The molecular weight distribution (Mw/Mn) of desirable plastomers ranges from 2 to 5 in one embodiment, and from 2.2 to 4 in another embodiment. Examples of a commercially available plastomers are EXACT™ 4150, a copolymer of ethylene and 1-hexene, the 1-hexene derived units making up from 18 to 22 wt % of the plastomer and having a density of 0.895 g/cm³ and MI of 3.5 dg/min (ExxonMobil Chemical Company, Houston, Tex.); and EXACT™ 8201, a copolymer of ethylene and 1-octene, the 1-octene derived units making up from 26 to 30 wt % of the plastomer, and having a density of 0.882 g/cm³ and MI of 1.0 dg/min (ExxonMobil Chemical Company, Houston, Tex.).

Polybutenes

In one aspect of the invention, a polybutene processing oil may be present in air barrier compositions. In one embodiment of the invention, the polybutene processing oil is a low molecular weight (less than 15,000 Mn) homopolymer or copolymer of olefin derived units having from 3 to 8 carbon atoms in one embodiment, preferably from 4 to 6 carbon atoms in another embodiment. In yet another embodiment, the polybutene is a homopolymer or copolymer of a C₄ raffinate. An embodiment of such low molecular weight polymers termed “polybutene” polymers is described in, for example, SYNTHETIC LUBRICANTS AND HIGH-PERFORMANCE FUNCTIONAL FLUIDS p 357-392 (Rudnick & Shubkin, ed., Marcel Dekker 1999) (hereinafter “polybutene processing oil” or “polybutene”).

In one embodiment of the invention, the polybutene processing oil is a copolymer of at least isobutylene derived units, 1-butene derived units, and 2-butene derived units. In one embodiment, the polybutene is a homopolymer, copolymer, or terpolymer of the three units, wherein the isobutylene derived units are from 40 to 100 wt % of the copolymer, the 1-butene derived units are from 0 to 40 wt % of the copolymer, and the 2-butene derived units are from 0 to 40 wt % of the copolymer. In another embodiment, the polybutene is a copolymer or terpolymer of the three units, wherein the isobutylene derived units are from 40 to 99 wt % of the copolymer, the 1-butene derived units are from 2 to 40 wt % of the copolymer, and the 2-butene derived units are from 0 to 30 wt % of the copolymer. In yet another embodiment, the polybutene is a terpolymer of the three units, wherein the isobutylene derived units are from 40 to 96 wt % of the copolymer, the 1-butene derived units are from 2 to 40 wt % of the copolymer, and the 2-butene derived units are from 2 to 20 wt % of the copolymer. In yet another embodiment, the polybutene is a homopolymer or copolymer of isobutylene and 1-butene, wherein the isobutylene derived units are from 65 to 100 wt % of the homopolymer or copolymer, and the 1-butene derived units are from 0 to 35 wt % of the copolymer.

Polybutene processing oils useful in the invention typically have a number average molecular weight (Mn) of less than 10,000 in one embodiment, less than 8000 in another embodiment, and less than 6000 in yet another embodiment. In one embodiment, the polybutene oil has a number average molecular weight of greater than 400, and greater than 700 in another embodiment, and greater than 900 in yet another embodiment. A preferred embodiment can be a combination of any lower molecular weight limit with any upper molecular weight limit herein. For example, in one embodiment of the polybutene of the invention, the polybutene has a number average molecular weight of from 400 to 10,000, and from 700 to 8000 in another embodiment, and from 900 to 3000 in yet another embodiment. Useful viscosities of the polybutene processing oil ranges from 10 to 6000 cSt (centiStokes) at 100° C. in one embodiment, and from 35 to 5000 cSt at 100° C. in another embodiment, and is greater than 35 cSt at 100° C. in yet another embodiment, and greater than 100 cSt at 100° C. in yet another embodiment.

Commercial examples of such a processing oil are the PARAPOL™ Series of processing oils (ExxonMobil Chemical Company, Houston, Tex.), such as PARAPOL™ 450, 700, 950, 1300, 2400 and 2500; ORONITE™ (ChevronTexaco, New Orleans, La.); DAELIM POLYBUTENE™ (Daelim Industrial Co., Ltd., Korea); INDOPOL™ (Innovene USA LLC, Lisle, Ill.); TPC PIB (Texas Petrochemicals, Houston, Tex.). The commercially available PARAPOL™ Series of polybutene processing oils are synthetic liquid polybutenes, each individual formulation having a certain molecular weight, all formulations of which can be used in the composition of the invention. The molecular weights of the PARAPOL™ oils are from 420 Mn (PARAPOL™ 450) to 2700 Mn (PARAPOL™ 2500) as determined by gel permeation chromatography. The MWD of the PARAPOL™ oils range from 1.8 to 3 in one embodiment, and from 2 to 2.8 in another embodiment.

The table below shows some of the properties of the PARAPOL™ oils useful in embodiments of the present invention, wherein the viscosity was determined as per ASTM D445, and the molecular weight by gel permeation chromatography.

TABLE 1
Properties of individual PARAPOL ™ Processing Aids

| | | Viscosity @ |
|---|---|---|
| Grade | Mn | 100° C., cSt |
| 450 | 420 | 10.6 |
| 700 | 700 | 78 |
| 950 | 950 | 230 |
| 1300 | 1300 | 630 |
| 2400 | 2350 | 3200 |
| 2500 | 2700 | 4400 |

Other properties of PARAPOL™ processing oils are as follows: the density (g/mL) of PARAPOL™ processing oils varies from about 0.85 (PARAPOL™ 450) to 0.91 (PARAPOL™ 2500). The bromine number (CG/G) for PARAPOL™ oils ranges from 40 for the 450 Mn processing oil, to 8 for the 2700 Mn processing oil.

The elastomeric composition of the invention may include one or more types of polybutene as a mixture, blended either prior to addition to the elastomer, or with the elastomer. The amount and identity (e.g., viscosity, Mn, etc.) of the polybutene processing oil mixture can be varied in this manner. Thus, PARAPOL™ 450 can be used when low viscosity is desired in the composition of the invention, while PARAPOL™ 2500 can be used when a higher viscosity is desired, or compositions thereof to achieve some other viscosity or molecular weight. In this manner, the physical properties of the composition can be controlled. More particularly, the phrases “polybutene processing oil”, or “polybutene processing oil” include a single oil or a composition of two or more oils used to obtain any viscosity or molecular weight (or other property) desired, as specified in the ranges disclosed herein.

The polybutene processing oil or oils are present in the elastomeric composition of the invention from 1 to 60 phr in one embodiment, and from 2 to 40 phr in another embodiment, from 4 to 35 phr in another embodiment, and from 5 to 30 phr in yet another embodiment, and from 2 to 10 phr in yet another embodiment, and from 5 to 25 phr in yet another embodiment, and from 2 to 20 phr in yet another embodiment, wherein a desirable range of polybutene may be any upper phr limit combined with any lower phr limit described herein. Preferably, the polybutene processing oil does not contain aromatic groups or unsaturation.

The polyolefin compositions of the present invention include a non-functionalized plastizer (“NFP”). The NFP of the present invention is a compound comprising carbon and hydrogen, and does not include to an appreciable extent functional groups selected from hydroxide, aryls and substituted aryls, halogens, alkoxys, carboxylates, esters, carbon unsaturation, acrylates, oxygen, nitrogen, and carboxyl. By “appreciable extent”, it is meant that these groups and compounds comprising these groups are not deliberately added to the NFP, and if present at all, are present to less than 5 wt % by weight of the NFP in one embodiment, and less than 1 wt % in another embodiment, and less than 0.5 wt % in yet another embodiment.

In one embodiment, the NFP consists of C₆ to C₂₀₀ paraffins, and C₈ to C₁₀₀ paraffins in another embodiment. In another embodiment, the NFP consists essentially of C₆ to C₂₀₀ paraffins, and consists essentially of C₈ to C₁₀₀ paraffins in another embodiment. For purposes of the present invention and description herein, the term “paraffin” includes all isomers such as n-paraffins, branched paraffins, isoparaffins, and may include cyclic aliphatic species, and blends thereof, and may be derived synthetically by means known in the art, or from refined crude oil in such a way as to meet the requirements described for desirable NFPs described herein. It will be realized that the classes of materials described herein that are useful as a NFPs can be utilized alone or admixed with other NFPs described herein in order to obtain the desired properties.

The NFP may be present in the polyolefin compositions of the invention from 0.1 to 60 wt % in one embodiment, and from 0.5 to 40 wt % in another embodiment, and from 1 to 20 wt % in yet another embodiment, and from 2 to 10 wt % in yet another embodiment, wherein a desirable range may comprise any upper wt % limit with any lower wt % limit described herein.

The NFP may also be described by any number of, or any combination of, parameters described herein. In one embodiment, the NFP of the present invention has a pour point of from less than 0° C. in one embodiment, and less than −5° C. in another embodiment, and less than −10° C. in another embodiment, less than −20° C. in yet another embodiment, less than −40° C. in yet another embodiment, less than −50° C. in yet another embodiment, and less than −60° C. in yet another embodiment, and greater than −120° C. in yet another embodiment, and greater than −200° C. in yet another embodiment, wherein a desirable range may include any upper pour point limit with any lower pour point limit described herein. In one embodiment, the NFP is a paraffin or other compound having a pour point of less than −30° C., and between −30° C. and −90° C. in another embodiment, in the viscosity range of from 0.5 to 200 cSt at 40° C. (ASTM D445). Most mineral oils, which typically include aromatic moieties and other functional groups, have a pour point of from 10° C. to −20° C. at the same viscosity range.

The NFP may have a dielectric constant at 20° C. of less than 3.0 in one embodiment, and less than 2.8 in another embodiment, less than 2.5 in another embodiment, and less than 2.3 in yet another embodiment, and less than 2.1 in yet another embodiment. Polyethylene and polypropylene each have a dielectric constant (1 kHz, 23° C.) of at least 2.3 (CRC HANDBOOK OF CHEMISTRY AND PHYSICS (Lide, ed. 82^{nd} ed. CRC Press 2001).

The NFP has a viscosity (ASTM D445) of from 0.1 to 3000 cSt at 100° C., and from 0.5 to 1000 cSt at 100° C. in another embodiment, and from 1 to 250 cSt at 100° C. in another embodiment, and from 1 to 200 cSt at 100° C. in yet another embodiment, and from 10 to 500 cSt at 100° C. in yet another embodiment, wherein a desirable range may comprise any upper viscosity limit with any lower viscosity limit described herein.

The NFP has a specific gravity (ASTM D4052, 15.6/15.6° C.) of less than 0.920 g/cm³ in one embodiment, and less than 0.910 g/cm³ in another embodiment, and from 0.650 to 0.900 g/cm³ in another embodiment, and from 0.700 to 0.860 g/cm³, and from 0.750 to 0.855 g/cm³ in another embodiment, and from 0.790 to 0.850 g/cm³ in another embodiment, and from 0.800 to 0.840 g/cm³ in yet another embodiment, wherein a desirable range may comprise any upper specific gravity limit with any lower specific gravity limit described herein. The NFP has a boiling point of from 100° C. to 800° C. in one embodiment, and from 200° C. to 600° C. in another embodiment, and from 250° C. to 500° C. in yet another embodiment. Further, the NFP has a weight average molecular weight (GPC or GC) of less than 20,000 g/mol in one embodiment, and less than 10,000 g/mol in yet another embodiment, and less than 5,000 g/mol in yet another embodiment, and less than 4,000 g/mol in yet another embodiment, and less than 2,000 g/mol in yet another embodiment, and less than 500 g/mol in yet another embodiment, and greater than 100 g/mol in yet another embodiment, wherein a desirable molecular weight range can be any combination of any upper molecular weight limit with any lower molecular weight limit described herein.

A compound suitable as an NFP for polyolefins of the present invention may be selected from commercially available compounds such as so called “isoparaffins”, “polyalphaolefins” (PAOs) and “polybutenes” (a subgroup of PAOs). These three classes of compounds can be described as paraffins which can include branched, cyclic, and normal structures, and blends thereof. These NFPs can be described as comprising C₆ to C₂₀₀ paraffins in one embodiment, and C₈ to C₁₀₀ paraffins in another embodiment.

Isoparaffins

The so called “isoparaffins” are described as follows. These paraffins are desirably isoparaffins, meaning that the paraffin chains possess C₁ to C₁₀ alkyl branching along at least a portion of each paraffin chain. The C₆ to C₂₀₀ paraffins may comprise C₆ to C₂₅ isoparaffins in one embodiment, and C₈ to C₂₀ isoparaffins in another embodiment.

More particularly, the isoparaffins are saturated aliphatic hydrocarbons whose molecules have at least one carbon atom bonded to at least three other carbon atoms or at least one side chain (i.e., a molecule having one or more tertiary or quaternary carbon atoms), and preferably wherein the total number of carbon atoms per molecule is in the range between 6 to 50, and between 10 and 24 in another embodiment, and from 10 to 15 in yet another embodiment. Various isomers of each carbon number will typically be present. The isoparaffins may also include cycloparaffins with branched side chains, generally as a minor component of the isoparaffin. The density (ASTM D4052, 15.6/15.6° C.) of these isoparaffins ranges from 0.70 to 0.83 g/cm³; a pour point of below −40° C. in one embodiment, and below −50° C. in another embodiment; a viscosity (ASTM 445, 25° C.) of from 0.5 to 20 cSt at 25° C.; and average molecular weights in the range of 100 to 300 g/mol. The isoparaffins are commercially available under the trade name ISOPAR (ExxonMobil Chemical Company, Houston Tex.), and are described in, for example, U.S. Pat. No. 6,197,285, U.S. Pat. No. 3,818,105 and U.S. Pat. No. 3,439,088, and sold commercially as ISOPAR™ series of isoparaffins.

TABLE 2
ISOPAR Series Isoparaffins

| | | | Avg. | | saturates |
|---|---|---|---|---|---|
| | distillation | | Specific | Viscosity @ | and |
| | range | pour point | Gravity | 25° C. | aromatics |
| name | (° C.) | (° C.) | (g/cm³) | (cSt) | (wt %) |
| ISOPAR E | 117-136 | −63 | 0.72 | 0.85 | <0.01 |
| ISOPAR G | 161-176 | −57 | 0.75 | 1.46 | <0.01 |
| ISOPAR H | 178-188 | −63 | 0.76 | 1.8 | <0.01 |
| ISOPAR K | 179-196 | −60 | 0.76 | 1.85 | <0.01 |
| ISOPAR L | 188-207 | −57 | 0.77 | 1.99 | <0.01 |
| ISOPAR M | 223-254 | −57 | 0.79 | 3.8 | <0.01 |
| ISOPAR V | 272-311 | −63 | 0.82 | 14.8 | <0.01 |

In another embodiment, the isoparaffins are a mixture of branched and normal paraffins having from 6 to 50 carbon atoms, and from 10 to 24 carbon atoms in another embodiment, in the molecule. The isoparaffin composition has an a branch paraffin:n-paraffin ratio ranging from 0.5:1 to 9:1 in one embodiment, and from 1:1 to 4:1 in another embodiment. The isoparaffins of the mixture in this embodiment contain greater than 50 wt % (by total weight of the isoparaffin composition) mono-methyl species, for example, 2-methyl, 3-methyl, 4-methyl, 5-methyl or the like, with minimum formation of branches with substituent groups of carbon number greater than 1, such as, for example, ethyl, propyl, butyl or the like, based on the total weight of isoparaffins in the mixture. In one embodiment, the isoparaffins of the mixture contain greater than 70 wt % of the mono-methyl species, based on the total weight of the isoparaffins in the mixture. The isoparaffinic mixture boils within a range of from 100° C. to 350° C. in one embodiment, and within a range of from 110° C. to 320° C. in another embodiment. In preparing the different grades, the paraffinic mixture is generally fractionated into cuts having narrow boiling ranges, for example, 35° C. boiling ranges. These branch paraffin/n-paraffin blends are described in, for example, U.S. Pat. No. 5,906,727.

Other suitable isoparaffins are also commercial available under the trade names SHELLSOL™ (Royal Dutch/Shell Group of Companies), SOLTROL™ (Chevron Phillips Chemical Co. LP) and SASOL™ (by Sasol Limited, Johannesburg, South Africa). Commercial examples are SHELLSOL™ (boiling point=215-260° C.), SOLTROL 220 (boiling point=233-280° C.), and SASOL LPA-210 and SASOL-47 (boiling point=238-274° C.).

Polyalphaolefins

The paraffins suitable as the NFP of the invention also include so called polyalphaolefins (PAOs), which are described as follows. The PAOs useful in the present invention comprise C₆ to C₂₀₀ paraffins, and C₁₀ to C₁₀₀ n-paraffins in another embodiment. The PAOs are dimers, trimers, tetramers, pentamers, etc. of C₄ to C₁₂ α-olefins in one embodiment, and C₅ to C₁₂ α-olefins in another embodiment. Suitable olefins include 1-butene, 1-pentene, 1-hexene, 1-heptene, 1-octene, 1-nonene, 1-decene, 1-undodecene and 1-dodecene. In one embodiment, the olefin is 1-decene, and the NFP is a mixture of dimers, trimers, tetramers and pentamers (and higher) of 1-decene. The PAOs are described more particularly in, for example, U.S. Pat. No. 5,171,908, and U.S. Pat. No. 5,783,531 and in SYNTHETIC LUBRICANTS AND HIGH-PERFORMANCE FUNCTIONAL FLUIDS, P 1-52 (Rudnick & Shubkin, ed. Marcel Dekker, Inc. 1999).

The PAOs of the present invention possess a weight average molecular weight of from 100 to 20,000 in one embodiment, and from 200 to 10,000 in another embodiment, and from 200 to 7,000 in yet another embodiment, and from 200 to 2,000 in yet another embodiment, and from 200 to 500 in yet another embodiment. Generally, PAOs have viscosities in the range of 0.1 to 150 cSt at 100° C., and from 0.1 to 3000 cSt at 100° C. in another embodiment (ASTM D445). The PAOs useful in the present invention have pour points of less than 0° C. in one embodiment, less than −10° C. in another embodiment, and less than −20° C. in yet another embodiment, and less than −40° C. in yet another embodiment. Desirable PAOs are commercially available as SHF and SuperSyn PAOs (ExxonMobil Chemical Company, Houston, Tex.).

TABLE 3
SHF and SuperSyn Series Polyalphaolefins

| | specific gravity | | | |
|---|---|---|---|---|
| | (g/cm³; | Viscosity | | |
| PAO | 15.6/15.6° C.) | 100° C., cSt | @ VI | Pour Point, ° C. |
| SHF-20 | 0.798 | 1.68 | — | −63 |
| SHF-21 | 0.800 | 1.70 | — | −57 |
| SHF-23 | 0.802 | 1.80 | — | −54 |
| SHF-41 | 0.818 | 4.00 | 123 | −57 |
| SHF-61/63 | 0.826 | 5.80 | 133 | −57 |
| SHF-82/83 | 0.833 | 7.90 | 135 | −54 |
| SHF-101 | 0.835 | 10.0 | 136 | −54 |
| SHF-403 | 0.850 | 40.0 | 152 | −39 |
| SHF-1003 | 0.855 | 107 | 179 | −33 |
| SuperSyn 2150 | 0.850 | 150 | 214 | −42 |
| SuperSyn 2300 | 0.852 | 300 | 235 | −30 |
| SuperSyn | 0.856 | 1,000 | 305 | −18 |
| 21000 | | | | |
| SuperSyn | 0.857 | 3,000 | 388 | −9 |
| 23000 | | | | |

Other processing aids include esters, polyethers, and polyalkylene glycols.

Other processing aids may be present or used in the manufacture of the elastomeric compositions of the invention. Processing aids include, but are not limited to, plasticizers, tackifiers, extenders, chemical conditioners, homogenizing agents and peptizers such as mercaptans, petroleum and vulcanized vegetable oils, mineral oils, paraffinic oils, polybutene aids, naphthenic oils, aromatic oils, waxes, resins, rosins, and the like.

Certain mineral oils, distinguished by their viscosity indices and the amount of saturates and sulfur they contain, have been classified as Hydrocarbon Basestock Group I, II or III by the American Petroleum Institute (API). Group I basestocks are solvent refined mineral oils. They contain the most unsaturates and sulfur and have the lowest viscosity indices.

Groups II and III are the High Viscosity Index and Very High Viscosity Index mineral oils. They are hydroprocessed mineral oils. The Group III oils contain less unsaturates and sulfur than the Group I oils and have higher viscosity indices than the Group II oils do. Rudnick and Shubkin in Synthetic Lubricants and High-Performance Functional Fluids, Second edition, Rudnick, Shubkin, eds., Marcel Dekker, Inc. New York, 1999, describe the mineral oils as typically being:

Group I—mineral oils refined using solvent extraction of aromatics, solvent dewaxing, hydrofining to reduce sulfur content to produce mineral oils with sulfur levels greater than 0.03 wt %, saturates levels of 60 to 80% and a viscosity index of about 90;

Group II—mildly hydrocracked mineral oils with conventional solvent extraction of aromatics, solvent dewaxing, and more severe hydrofining to reduce sulfur levels to less than or equal to 0.03 wt % as well as removing double bonds from some of the olefinic and aromatic compounds, saturate levels are greater than 95-98% and VI is about 80-120; and

Group III—severely hydrotreated mineral oils with saturates levels of some oils virtually 100%, sulfur contents are less than or equal to 0.03 wt % (preferably between 0.001 and 0.01%) and VI is in excess of 120.

The processing aid is typically present or used in the manufacturing process from 1 to 70 phr in one embodiment, from 3 to 60 phr in another embodiment, and from 5 to 50 phr in yet another embodiment.

In one embodiment of the invention, paraffinic, naphthenic and/or aromatic oils are substantially absent, meaning, they have not been deliberately added to the compositions, or, in the alternative, if present, are only present up to 0.2 wt % of the compositions used to make the air barriers.

Fillers

The elastomeric composition may have one or more filler components such as, for example, calcium carbonate, silica, clay and other silicates which may or may not be exfoliated, mica, talc, titanium dioxide, and carbon black.

The fillers of the present invention may be any size and typically range, for example, from about 0.0001 μm to about 100 μm. As used herein, silica is meant to refer to any type or particle size silica or another silicic acid derivative, or silicic acid, processed by solution, pyrogenic or the like methods and having a surface area, including untreated, precipitated silica, crystalline silica, colloidal silica, aluminum or calcium silicates, fumed silica, and the like.

In one embodiment, the filler is carbon black or modified carbon black, and combinations of any of these. In another embodiment, the filler is a blend of carbon black and silica. The preferred filler for such articles as tire treads and sidewalls is reinforcing grade carbon black present at a level of from 10 to 100 phr of the blend, more preferably from 30 to 80 phr in another embodiment, and from 50 to 80 phr in yet another embodiment. Useful grades of carbon black, as described in RUBBER TECHNOLOGY, p 59-85, range from N110 to N990. More desirably, embodiments of the carbon black useful in, for example, tire treads are N229, N351, N339, N220, N234 and N110 provided in ASTM (D3037, D1510, and D3765). Embodiments of the carbon black useful in, for example, sidewalls in tires, are N330, N351, N550, N650, N660, and N762. Carbon blacks suitable for innerliners and other air barriers include N550, N660, N650, N762, N990 and Regal 85.

The layered filler may comprise a layered clay, optionally, treated or pre-treated with a modifying agent such as organic molecules. The elastomeric compositions may incorporate a clay, optionally, treated or pre-treated with a modifying agent, to form a nanocomposite or nanocomposite composition.

Nanocomposites may include at least one elastomer as described above and at least one modified layered filler. The modified layered filler may be produced by the process comprising contacting at least one layered filler such as at least one layered clay with at least one modifying agent.

The modified layered filler may be produced by methods and using equipment well within the skill in the art. For example, see U.S. Pat. No. 4,569,923, U.S. Pat. No. 5,663,111, U.S. Pat. No. 6,036,765, and U.S. Pat. No. 6,787,592. Illustrations of such methods are demonstrated in the Example section. However, by no means is this meant to be an exhaustive listing.

In an embodiment, the layered filler such as a layered clay may comprise at least one silicate.

In certain embodiments, the silicate may comprise at least one “smectite” or “smectite-type clay” referring to the general class of clay minerals with expanding crystal lattices. For example, this may include the dioctahedral smectites which consist of montmorillonite, beidellite, and nontronite, and the trioctahedral smectites, which includes saponite, hectorite, and sauconite. Also encompassed are smectite-clays prepared synthetically, e.g., by hydrothermal processes as disclosed in U.S. Pat. No. 3,252,757, U.S. Pat. No. 3,586,468, U.S. Pat. No. 3,666,407, U.S. Pat. No. 3,671,190, U.S. Pat. No. 3,844,978, U.S. Pat. No. 3,844,979, U.S. Pat. No. 3,852,405, and U.S. Pat. No. 3,855,147.

In yet other embodiments, the at least one silicate may comprise natural or synthetic phyllosilicates, such as montmorillonite, nontronite, beidellite, bentonite, volkonskoite, laponite, hectorite, saponite, sauconite, magadite, kenyaite, stevensite and the like, as well as vermiculite, halloysite, aluminate oxides, hydrotalcite, and the like. Combinations of any of the previous embodiments are also contemplated.

The layered filler such as the layered clays described above may be modified such as intercalated or exfoliated by treatment with at least one modifying agent or swelling agent or exfoliating agent or additive capable of undergoing ion exchange reactions with the cations present at the interlayer surfaces of the layered filler.

Modifying agents are also known as swelling or exfoliating agents. Generally, they are additives capable of undergoing ion exchange reactions with the cations present at the interlayer surfaces of the layered filler. Suitable exfoliating additives include cationic surfactants such as ammonium, alkylamines or alkylammonium (primary, secondary, tertiary and quaternary), phosphonium or sulfonium derivatives of aliphatic, aromatic or arylaliphatic amines, phosphines and sulfides.

For example, amine compounds (or the corresponding ammonium ion) are those with the structure R²R³R⁴N, wherein R², R³, and R⁴ are C₁ to C₃₀ alkyls or alkenes in one embodiment, C₁ to C₂₀ alkyls or alkenes in another embodiment, which may be the same or different. In one embodiment, the exfoliating agent is a so-called long chain tertiary amine, wherein at least R² is a C₁₄ to C₂₀ alkyl or alkene.

In other embodiments, a class of exfoliating additives include those which can be covalently bonded to the interlayer surfaces. These include polysilanes of the structure —Si(R⁵)₂R⁶ where R⁵ is the same or different at each occurrence and is selected from alkyl, alkoxy or oxysilane and R⁶ is an organic radical compatible with the matrix polymer of the composite.

Other suitable exfoliating additives include protonated amino acids and salts thereof containing 2-30 carbon atoms such as 12-aminododecanoic acid, epsilon-caprolactam and like materials. Suitable swelling agents and processes for intercalating layered silicates are disclosed in U.S. Pat. No. 4,472,538, U.S. Pat. No. 4,810,734, and U.S. Pat. No. 4,889,885 as well as WO 92/02582.

In an embodiment, the exfoliating additive or additives are capable of reacting with the halogen sites of the halogenated elastomer to form complexes which help exfoliate the clay. In certain embodiments, the additives include all primary, secondary and tertiary amines and phosphines; alkyl and aryl sulfides and thiols; and their polyfunctional versions. Desirable additives include: long-chain tertiary amines such as N,N-dimethyl-octadecylamine, N,N-dioctadecyl-methylamine, so called dihydrogenated tallowalkyl-methylamine and the like, and amine-terminated polytetrahydrofuran; long-chain thiol and thiosulfate compounds like hexamethylene sodium thiosulfate.

In yet other embodiments, modifying agents include at least one polymer chain comprising a carbon chain length of from C₂₅ to C₅₀₀, wherein the polymer chain also comprises an ammonium-functionalized group described by the following group pendant to the polymer chain E: 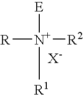
wherein each R, R¹ and R² are the same or different and independently selected from hydrogen, C₁ to C₂₆ alkyl, alkenes or aryls, substituted C₁ to C₂₆ alkyls, alkenes or aryls, C₁ to C₂₆ aliphatic alcohols or ethers, C₁ to C₂₆ carboxylic acids, nitrites, ethoxylated amines, acrylates and esters; and wherein X is a counterion of ammonium such as Br⁻, Cl⁻ or PF₆⁻.

The modifying agent such as described herein is present in the composition in an amount to achieve optimal air retention as measured by the permeability testing described herein. For example, but not limited to, the additive may be employed from 0.1 to 40 phr in one embodiment, and from 0.2 to 20 phr in another embodiment, and from 0.3 to 10 phr in yet another embodiment.

The exfoliating additive may be added to the composition at any stage; for example, the additive may be added to the elastomer, followed by addition of the layered filler, or may be added to a combination of at least one elastomer and at least one layered filler; or the additive may be first blended with the layered filler, followed by addition of the elastomer in yet another embodiment.

Examples of some commercial products are Cloisites produced by Southern Clay Products, Inc. in Gunsalas, Tex. For example, Cloisite Na⁺, Cloisite 30B, Cloisite 10A, Cloisite 25A, Cloisite 93A, Cloisite 20A, Cloisite 15A, and Cloisite 6A. They are also available as SOMASIF and LUCENTITE clays produced by CO-OP Chemical Co., LTD. In Tokyo, Japan. For example, SOMASIF™ MAE, SOMASIF™ MEE, SOMASIF™ MPE, SOMASIF™ MTE, SOMASIF™ ME-100, LUCENTITE™ SPN, and LUCENTITE(SWN).

The amount of clay or exfoliated clay incorporated in the nanocomposites in accordance with an embodiment of the invention is sufficient to develop an improvement in the mechanical properties or barrier properties of the nanocomposite, for example, tensile strength or oxygen permeability. Amounts generally will range from 0.5 to 10 wt % in one embodiment, and from 1 to 5 wt % in another embodiment, based on the polymer content of the nanocomposite. Expressed in parts per hundred rubber, the clay or exfoliated clay may be present from 1 to 30 phr in one embodiment, and from 5 to 20 phr in another embodiment.

Crosslinking Agents, Curatives, Cure Packages, and Curing Processes

In certain embodiments, the elastomeric compositions and the articles made from those compositions may comprise or be manufactured with the aid of at least one cure package, at least one curative, at least one crosslinking agent, and/or undergo a process to cure the elastomeric composition. As used herein, at least one curative package refers to any material or method capable of imparting cured properties to a rubber as commonly understood in the industry. At least one curative package may include any and at least one of the following.

One or more crosslinking agents are preferably used in the elastomeric compositions of the present invention, especially when silica is the primary filler, or is present in combination with another filler. Crosslinking and curing agents include sulfur, zinc oxide, and fatty acids. More preferably, the coupling agent may be a bifunctional organosilane crosslinking agent. An “organosilane crosslinking agent” is any silane coupled filler and/or crosslinking activator and/or silane reinforcing agent known to those skilled in the art including, but not limited to, vinyl triethoxysilane, vinyl-tris-(beta-methoxyethoxy)silane, methacryloylpropyltrimethoxysilane, gamma-amino-propyl triethoxysilane (sold commercially as A1100 by Witco), gamma-mercaptopropyltrimethoxysilane (A189 by Witco) and the like, and mixtures thereof. In one embodiment, bis-(3-triethoxysilypropyl)tetrasulfide (sold commercially as Si69 by Degussa) is employed.

Peroxide cure systems or resin cure systems may also be used.

Heat or radiation-induced crosslinking of polymers may be used.

Generally, polymer blends, for example, those used to produce tires, are crosslinked thereby improve the polymer's mechanical properties. It is known that the physical properties, performance characteristics, and durability of vulcanized rubber compounds are directly related to the number (crosslink density) and type of crosslinks formed during the vulcanization reaction. (See, e.g., Helt et al., The Post Vulcanization Stabilization for NR in RUBBER WORLD, p 18-23 (1991)).

Sulfur is the most common chemical vulcanizing agent for diene-containing elastomers. It exists as a rhombic 8-member ring or in amorphous polymeric forms. The sulfur vulcanization system also consists of the accelerator to activate the sulfur, an activator, and a retarder to help control the rate of vulcanization. Accelerators serve to control the onset of and rate of vulcanization, and the number and type of sulfur crosslinks that are formed. These factors play a significant role in determining the performance properties of the vulcanizate.

Activators are chemicals that increase the rate of vulcanization by reacting first with the accelerators to form rubber-soluble complexes which then react with the sulfur to form sulfurating agents. General classes of accelerators include amines, diamines, guanidines, thioureas, thiazoles, thiurams, sulfenamides, sulfenimides, thiocarbamates, xanthates, and the like.

Retarders may be used to delay the initial onset of cure in order to allow sufficient time to process the unvulcanized rubber.

Halogen-containing elastomers such as halogenated star-branched butyl rubber, brominated butyl rubber, chlorinated butyl rubber, star-branched brominated butyl (polyisobutylene/isoprene copolymer) rubber, halogenated poly(isobutylene-co-p-methylstyrene), polychloroprene, and chlorosulfonated polyethylene may be crosslinked by their reaction with metal oxides. The metal oxide is thought to react with halogen groups in the polymer to produce an active intermediate which then reacts further to produce carbon-carbon bonds. Zinc halide is liberated as a by-product and it serves as an autocatalyst for this reaction.

Generally, polymer blends may be crosslinked by adding curative molecules, for example sulfur, metal oxides, organometallic compounds, radical initiators, etc., followed by heating. In particular, the following metal oxides are common curatives that will function in the present invention: ZnO, CaO, MgO, Al₂O₃, CrO₃, FeO, Fe₂O₃, and NiO. These metal oxides can be used alone or in conjunction with the corresponding metal fatty acid complex (e.g., zinc stearate, calcium stearate, etc.), or with the organic and fatty acids added alone, such as stearic acid, and optionally other curatives such as sulfur or a sulfur compound, an alkylperoxide compound, diamines or derivatives thereof (e.g., DIAK products sold by DuPont). (See also, Formulation Design and Curing Characteristics of NBR Mixes for Seals, RUBBER WORLD, p 25-30 (1993)). This method of curing elastomers may be accelerated and is often used for the vulcanization of elastomer blends.

The acceleration of the cure process is accomplished in the present invention by adding to the composition an amount of an accelerant, often an organic compound. The mechanism for accelerated vulcanization of natural rubber involves complex interactions between the curative, accelerator, activators and polymers. Ideally, all of the available curative is consumed in the formation of effective crosslinks which join together two polymer chains and enhance the overall strength of the polymer matrix. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), benzothiazyl disulfide (MBTS), hexamethylene-1,6-bisthiosulfate disodium salt dihydrate (sold commercially as DURALINK™ HTS by Flexsys), 2-morpholinothio benzothiazole (MBS or MOR), blends of 90% MOR and 10% MBTS (MOR 90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), and “thioureas”.

Other Components

The compositions produced in accordance with the present invention typically contain other components and additives customarily used in rubber mixes, such as effective amounts of other nondiscolored and nondiscoloring processing aids, pigments, antioxidants, and/or antiozonants.

### INDUSTRIAL APPLICABILTY

The elastomeric compositions of the invention may be extruded, compression molded, blow molded, injection molded, and laminated into various shaped articles including fibers, films, laminates, layers, industrial parts such as automotive parts, appliance housings, consumer products, packaging, and the like.

In particular, the elastomeric compositions are useful in articles for a variety of tire applications such as truck tires, bus tires, automobile tires, motorcycle tires, off-road tires, aircraft tires, and the like. The elastomeric compositions may either be fabricated into a finished article or a component of a finished article such as an innerliner for a tire. The article may be selected from air barriers, air membranes, films, layers (microlayers and/or multilayers), innerliners, innertubes, sidewalls, treads, bladders, envelopes, and the like.

In another application, the elastomeric compositions may be employed in air cushions, pneumatic springs, air bellows, hoses, accumulator bags, and belts such as conveyor belts or automotive belts.

They are useful in molded rubber parts and find wide applications in automobile suspension bumpers, auto exhaust hangers, and body mounts.

Additionally, the elastomeric compositions may also be used as adhesives, caulks, sealants, and glazing compounds. They are also useful as plasticizers in rubber formulations; as components to compositions that are manufactured into stretch-wrap films; as dispersants for lubricants; and in potting and electrical cable filling materials.

In yet other applications, the elastomer(s) or elastomeric compositions of the invention are also useful in chewing-gum, as well as in medical applications such as pharmaceutical stoppers and closures, coatings for medical devices, and the arts for paint rollers.

All priority documents, patents, publications, and patent applications, test procedures (such as ASTM methods), and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

### EXAMPLES

Processing

Suitable elastomeric compositions for such articles as air barriers, and more particularly innerliners were prepared by using conventional mixing techniques including, for example, kneading, roller milling, extruder mixing, internal mixing (such as with a Banbury™ or Brabender™ mixer) etc. Blends of elastomers may be reactor blends and/or melt mixes. The sequence of mixing and temperatures employed are well known to the skilled rubber compounder, the objective being the dispersion of fillers, activators and curatives in the polymer matrix without excessive heat buildup. Table 4 is a list of useful components for the compositions exemplified.

TABLE 4
Various Components in the Compositions

| Component | Brief Description | Commercial Source |
|---|---|---|
| Bromobutyl-2222 | Brominated butyl rubber, | ExxonMobil Chemical |
| | 27-37 Mooney Viscosity | Company (Houston, TX) |
| EXXPRO ™ | brominated | ExxonMobil Chemical |
| 03-1 | poly(isobutylene-co-p- | Company (Houston, TX) |
| | methylstyrene), 0.85 ± 0.1 | |
| | mol % benzylic Br; | |
| | 10 ± 0.5 p-methylstyrene, | |
| | 27-37 Mooney Viscosity | |
| CALSOL ™ 810 | Naphthenic Oil | R.E. Carroll, Inc |
| | ASTM Type 103 | (Trenton, NJ) |
| PARAPOL ™ | C₄ raffinate | ExxonMobil Chemical |
| | | Company (Houston, TX) |
| Soltex, PB124 | Polyisobutylene | Texas Petrochemicals |
| | | (Houston, TX) |
| SP-1068 | Alkyl phenol | Schenectady Int. |
| | formaldehyde resin | (Schenectady, NY) |
| STRUKTOL ™ | Composition of aliphatic- | Struktol Co. of America |
| 40 MS | aromatic-naphthenic | (Stow, OH) |
| | resins | |
| KADOX ™ 930 | High Purity French | Zinc Corp. of America |
| | Process Zinc Oxide | (Monaca, PA) |
| MBTS | 2-Mercaptobenzothiazole | R. T. Vanderbilt |
| | disulfide | (Norwalk, CT) or |
| | | Elastochem (Chardon, |
| | | OH) |

A Banbury™ mixer was used to combine the copolymer rubber, carbon black and plasticizer. The composition was mixed for a time and at temperature to achieve adequate dispersion of the ingredients. However, as is well known in the art, mixing of the components may be carried out by combining the polymer components, filler and the clay in the form of an intercalate in any suitable mixing device such as a two-roll open mill, Brabender™ internal mixer, Banbury™ internal mixer with tangential rotors, Krupp internal mixer with intermeshing rotors, or preferably a mixer/extruder. Mixing is performed at temperatures in the range from up to the melting point of the elastomer and/or secondary rubber used in the composition in one embodiment, from 40° C. up to 250° C. in another embodiment, and from 100° C. to 200° C. in yet another embodiment, under conditions of shear sufficient to allow the clay intercalate to exfoliate and become uniformly dispersed within the polymer to form the nanocomposite.

Typically, from 70% to 100% of the elastomer or elastomers is first mixed for 20 to 90 seconds, or until the temperature reaches from 40° C. to 75° C. Then, ¾ of the filler, and the remaining amount of elastomer, if any, are typically added to the mixer, and mixing continues until the temperature reaches from 90° C. to 150° C. Next, the remaining filler is added, as well as the processing aid, and mixing continues until the temperature reaches from 140° C. to 190° C. The masterbatch mixture is then finished by sheeting on an open mill and allowed to cool, for example, to from 60° C. to 100° C. when the curatives are added.

Mixing with the clays is performed by techniques known to those skilled in the art, wherein the clay is added to the polymer at the same time as the carbon black in one embodiment. The processing aid is typically added later in the mixing cycle after the carbon black and clay have achieved adequate dispersion in the elastomeric matrix.

An innerliner stock was then prepared by calendering the compounded rubber composition into sheet material having a thickness of roughly 40 to 80 mil gauge and cutting the sheet material into strips of appropriate width and length for innerliner applications.

The sheet stock at this stage of the manufacturing process is a sticky, uncured mass and is therefore subject to deformation and tearing as a consequence of handling and cutting operations associated with tire construction.

The innerliner is then ready for use as an element in the construction of a pneumatic tire. The pneumatic tire is composed of a layered laminate comprising an outer surface which includes the tread and sidewall elements, an intermediate carcass layer which comprises a number of plies containing tire reinforcing fibers, (e.g., rayon, polyester, nylon or metal fibers) embedded in a rubbery matrix and an innerliner layer which is laminated to the inner surface of the carcass layer. The tires were built on a tire forming drum using the layers described above. After the uncured tire has been built on the drum, the uncured tire was placed in a heated mold having an inflatable tire shaping bladder to shape it and heat it to vulcanization temperatures by methods well known in the art. Vulcanization temperatures generally range from about 100° C. to about 250° C., more preferably from 125° C. to 200° C., and times may range from about one minute to several hours, generally, from about 5 to 30 minutes. Vulcanization of the assembled tire results in vulcanization of all elements of the tire assembly, for example, the innerliner, the carcass and the outer tread/sidewall layers and enhances the adhesion between these elements, resulting in a cured, unitary tire from the multi-layers.

Testing

Test methods are summarized in Table 5.

Cure properties were measured using a MDR 2000 and 0.5 degree arc at the indicated temperature. Test specimens were cured at the indicated temperature, typically from 150° C. to 160° C., for a time corresponding to t90+appropriate mold lag. The values “MH” and “ML” used here and throughout the description refer to “maximum torque” and “minimum torque”, respectively. The “MS” value is the Mooney scorch value, the “ML(1+4)” value is the Mooney viscosity value. The error (2σ) in the later measurement is ±0.65 Mooney viscosity units. The values of “t” are cure times in minutes, and “ts” is scorch time” in minutes.

When possible, standard ASTM tests were used to determine the cured compound physical properties (see Table 5). Stress/strain properties (tensile strength, elongation at break, modulus values, energy to break) were measured at room temperature using an Instron 4202 or an Instron Series IX Automated Materials Testing System 6.03.08. Tensile measurements were done at ambient temperature on specimens (dog-bone shaped) width of 0.25 inches (0.62 cm) and a length of 1.0 inches (2.5 cm) length (between two tabs) were used. The thickness of the specimens varied and was measured manually by Mitutoyo Digimatic Indicator connected to the system computer. The specimens were pulled at a crosshead speed of 20 inches/min. (51 cm/min.) and the stress/strain data was recorded. The average stress/strain value of at least three specimens is reported. The error (2σ) in Tensile strength measurements is ±0.47 MPa units. The error (2σ) in measuring 100% Modulus is ±0.11 MPa units; the error (2σ) in measuring Elongation at break is ±13% units. Shore A hardness was measured at room temperature by using a Zwick Duromatic.

Oxygen permeability was measured using a MOCON OxTran Model 2/61 operating under the principle of dynamic measurement of oxygen transport through a thin film as published by Pasternak et al. in 8 JOURNAL OF POLYMER SCIENCE: PART A-2, P 467 (1970). The units of measure are cc-mm/m²-day-mmHg. Generally, the method is as follows: flat film or rubber samples are clamped into diffusion cells which are purged of residual oxygen using an oxygen free carrier gas. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Permeability was tested by the following method. Thin, vulcanized test specimens from the sample compositions were mounted in diffusion cells and conditioned in an oil bath at 65° C. The time required for air to permeate through a given specimen is recorded to determine its air permeability. Test specimens were circular plates with 12.7-cm diameter and 0.38-mm thickness. The error (2σ) in measuring air permeability is ±0.245 (×10⁸) units.

Cured compositions of the invention will have an air permeability of from less than 3.25×10⁻⁸ cm³·cm/cm²·sec·atm in one embodiment, and less than 3.0×10⁻⁸ cm³·cm/cm²·sec·atm in another embodiment. This improved the most when a polybutene processing oil was also present. In that case, the cured compositions will have an air permeability of less than 2.75×10⁻⁸ cm³·cm/cm²·sec·atm in one embodiment, and less than 2.5×10⁻⁸ cm³·cm/cm²·sec·atm in another embodiment when polybutene processing oil is present from 5 to 25 phr. In one embodiment, the number average molecular weight range of the useful polybutene processing oil ranges from 500 to 2500.

Inflation Pressure Retention (IPR) was tested in accordance to ASTM F1112 by the following method: The tires were mounted on standard rims and inflated to 240 kPa±3.5 kPa. A T-adapter is connected to the valve allowing a calibrated gauge to be connected to one side and inflation air to be added through the other. The tires are checked for leaks, conditioned for 48 hours @ 21° C.±3° C. for 48 hours and again checked for leaks. The inflation pressure is then recorded over a three month time frame. The IPR is reported as the inflation pressure loss per month.

In an embodiment, the tire may comprise an article comprising a composition comprising an effective amount of the at least one halogenated random copolymer to impart to the tire an Inflation Pressure Retention (IPR) (as herein defined) of 2.0 or lower.

In an embodiment, the tire may comprise an article comprising a composition comprising an effective amount of the at least one halogenated random copolymer to impart to the tire an Inflation Pressure Retention (IPR) (as herein defined) of 1.8 or lower.

In an embodiment, the tire may comprise an article comprising a composition comprising an effective amount of the at least one halogenated random copolymer to impart to the tire an Inflation Pressure Retention (IPR) (as herein defined) of 1.6 or lower.

The Intracarcass Pressure (ICP) is proceeds as follows: The tires are mounted on standard rims and inflated to 240 kPa±3.5 kPa. The tires are connected to a constant inflation pressure system, which uses a calibrated gauge to maintain the inflation at 240 kPa±3.5 kPa. The tires are checked for leaks, conditioned for 48 hours @ 21° C.±3° C. and again checked for leaks. Typically five calibrated gauges with hypodermic needles are then inserted into the tire with the tip of the needle set on the carcass cord. The readings are taken until the pressure at the cord interface equilibrates (normally 2 months). The ICP is reported as the average of the readings.

In an embodiment, the tire may comprise an article comprising a composition comprising an effective amount of the at least one halogenated random copolymer to impart to the tire an Intracarcass (ICP) (as herein defined) of 80 or lower.

In an embodiment, the tire may comprise an article comprising a composition comprising an effective amount of the at least one halogenated random copolymer to impart to the tire an Intracarcass (ICP) (as herein defined) of 75 or lower.

In an embodiment, the tire may comprise an article comprising a composition comprising an effective amount of the at least one halogenated random copolymer to impart to the tire an Intracarcass (ICP) (as herein defined) of 70 or lower.

In an embodiment, the tire may comprise an article comprising a composition comprising an effective amount of the at least one halogenated random copolymer to impart to the tire an Intracarcass (ICP) (as herein defined) of 65 or lower.

In an embodiment, the tire may comprise an article comprising a composition comprising an effective amount of the at least one halogenated random copolymer to impart to the tire an Intracarcass (ICP) (as herein defined) of 60 or lower.

In an embodiment, the tire may comprise an article comprising a composition comprising an effective amount of the at least one halogenated random copolymer to impart to the tire an Intracarcass (ICP) (as herein defined) of 55 or lower.

Tires were run according to the procedures specified in the Federal Motor Vehicle Safety Standards No. 139 (see Federal Register/Vol. 68, No. 123, p 38116). Tests performed were FMVSS 139 High Speed, FMVSS 139 Endurance, and FMVSS 139 Low Inflation tests. Tires were mounted on reinforced steel rims of standard size. Tires were inflated with air to the specified test pressures. For the FMVSS 139 Low Inflation and Endurance tests a pressure of 220 kPa±3.5 kPa of air inflation was used. For the FMVSS 139 Low Inflation test a pressure of 140 kPa±3.5 kPa of air inflation was used. Tires were tested at the specified load and speed steps for the specified time intervals against a 1.707 m wheel running at the specified speeds in a room at 38° C.±3° C.

Tire Durability Tests were also run according to FMVSS 139 procedures but after successful completion of the specified FMVSS 139 tests, tires were allowed to continue to run against the wheel until a failure terminated the test by automatically tripping a detector to shut off the machine. Tests performed were FMVSS 139 High Speed to failure, FMVSS 139 Endurance to failure, and FMVSS 139 Low Inflation to failure. As used herein, FMVSS 139 Endurance to failure is called Tire Durability.

In an embodiment, the tire may comprise an article comprising a composition comprising an effective amount of the at least one halogenated random copolymer to impart to the tire a Tire Durability (as herein defined) of 75 or higher.

In an embodiment, the tire may comprise an article comprising a composition comprising an effective amount of the at least one halogenated random copolymer to impart to the tire a Tire Durability (as herein defined) of 100 or higher.

In an embodiment, the tire may comprise an article comprising a composition comprising an effective amount of the at least one halogenated random copolymer to impart to the tire a Tire Durability (as herein defined) of 125 or higher.

In an embodiment, the tire may comprise an article comprising a composition comprising an effective amount of the at least one halogenated random copolymer to impart to the tire a Tire Durability (as herein defined) of 150 or higher.

The composition can be used to make any number of articles. In one embodiment, the article is selected from tire curing bladders, tire curing envelopes, tire innerliners, tire innertubes, and air sleeves. Other useful goods that can be made using compositions of the invention include hoses, seals, molded goods, cable housing, and other articles disclosed in THE VANDERBILT RUBBER HANDBOOK, P 637-772 (Ohm, ed., R.T. Vanderbilt Company, Inc. 1990).

Thus, one aspect of the invention is a composition suitable for an air barrier comprising an elastomer comprising C₄ to C₇ isoolefin derived units; and a polybutene processing aid. Further, naphthenic and aromatic oils are substantially absent from the composition in one embodiment.

In one embodiment, the polybutene processing aid is present in the composition from 1 to 40 phr, and from 2 to 30 phr in another embodiment, and from 3 to 20 phr in another embodiment, and from 3 to 15 phr in yet another embodiment.

In another aspect of the composition, the composition also comprises a processing oil. The oil is selected from paraffinic oils and the polybutene processing aids, and mixtures thereof in one embodiment, and is a polybutene processing aid in another embodiment. Rosin oils may be present in compositions of the invention from 0.1 to 5 phr in one embodiment, and from 0.2 to 2 phr in another embodiment. Desirably, oils and processing aids comprising unsaturation comprise less than 2 phr of the compositions of the invention in one embodiment.

The composition may also include a filler selected from carbon black, modified carbon black, silicates, clay, exfoliated clay, and mixtures thereof.

In another embodiment, the composition also comprises a secondary rubber selected from natural rubbers, polyisoprene rubber, styrene-butadiene rubber (SBR), polybutadiene rubber, isoprene-butadiene rubber (IBR), styrene-isoprene-butadiene rubber (SIBR), ethylene-propylene rubber, ethylene-propylene-diene rubber (EPDM), polysulfide, nitrile rubber, propylene oxide polymers, poly(isobutylene-co-p-methylstyrene), halogenated poly(isobutylene-co-p-methylstyrene), poly(isobutylene-co-cyclopentadiene), halogenated poly(isobutylene-co-cyclopentadiene), and mixtures thereof. In another embodiment, the composition also comprises from 5 to 30 phr of a natural rubber.

The elastomer useful in the present invention comprises C₄ to C₇ isoolefin derived units. The C₄ to C₇ isoolefin derived units may be selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene.

Further, the elastomer also comprises multiolefin derived units selected from isoprene, butadiene, 2,3-dimethyl-1,3-butadiene, myrcene, 6,6-dimethyl-fulvene, hexadiene, cyclopentadiene, and piperylene in another embodiment.

In yet another embodiment of a useful elastomer, the elastomer also comprises styrenic derived units selected from styrene, chlorostyrene, methoxystyrene, indene and indene derivatives, α-methylstyrene, o-methylstyrene, m-methylstyrene, and p-methylstyrene, and p-tert-butylstyrene.

The elastomer is halogenated in one embodiment.

The composition of the invention may also be cured using a curative. In one embodiment, the composition also comprises a curative selected from sulfur, sulfur-based compounds, metal oxides, metal oxide complexes, fatty acids, peroxides, diamines, and mixtures thereof.

The composition can be used to make any number of articles. In one embodiment, the article is selected from tire curing bladders, innerliners, tire innertubes, and air sleeves. Other useful goods that can be made using compositions of the invention include hoses, seals, molded goods, cable housing, and other articles disclosed in THE VANDERBILT RUBBER HANDBOOK 637-772 (R.T. Vanderbilt Company, Inc. 1990).

TABLE 5
Test Methods

| Parameter | Units | Test |
|---|---|---|
| Mooney Viscosity (polymer) | ML 1 + 8, 125° C., MU | ASTM D1646 |
| Mooney Viscosity (composition) | ML 1 + 4, 100° C., MU | ASTM D1646 |
| Green Strength (100% Modulus) | PSI | ASTM D412 |
| MOCON (@ 60° C.) | cc-mm/m²-day- | See text |
| | mmHg | |
| Air Permeability (@ 65° C.) | (cm³-cm/cm²-sec- | See text |
| | atm) × 10⁸ | |
| Mooney Scorch Time | ts5, 125° C., minutes | ASTM D1646 |
| Oscillating Disk Rheometer | | ASTM D2084 |
| (ODR) @ 160° C. ±3°arc | | |
| Moving Die Rheometer (MDR) @160° C., | | |
| ±0.5°arc | | |
| ML | deciNewton.meter | |
| MH | dNewton.m | |
| ts2 | minutes | |
| t50 | minutes | |
| t90 | minutes | |
| Physical Properties, press cured | | |
| Tc 90 + 2 min @ 160° C. | | |
| Hardness | Shore A | ASTM D2240 |
| Modulus 20%, 100%, 300% | MPa | ASTM D412 die C |
| Tensile Strength | MPa | |
| Elongation at Break | % | |
| Energy to Break | N/mm (J) | |
| Hot Air Aging, 72 hrs. @ 125° C. | | |
| Hardness | Shore A | ASTM D573 |
| Modulus 20%, 100%, 300% | MPa | |
| Tensile Strength | MPa | |
| Elongation at Break | % | |
| Energy to Break | N/mm (J) | |
| DeMattia Flex | mm @ kilocycles | ASTM D813 |
| | | modified |

Table 6 shows comparative examples. Control 1 is a tire innerliner compound comprising EXXPRO and a processing oil. Experimental 2 illustrates the tire innerliner compound comprising EXXPRO and a polybutene liquid polymer of the invention, with the processing oil used in Control 1 being essentially absent. The comparative examples were cured at 180° C. for a time equivalent to T90+appropriate mold lag time for the test.

TABLE 6
Components of Comparative and Experimental Compositions 1-2

| Ingredient | Control 1 | Expt 2 |
|---|---|---|
| EXXPRO, MDX 03-1 | 100 | 100 |
| Resin, SP1068 | 4 | 4 |
| Carbon Black, N660 | 60 | 60 |
| Resin, STRUKTOL 40 MS | 7 | 7 |
| Process oil, TDAE | 8 | |
| Polybene, Soltex PB124 | | 8 |
| Stearic Acid | 1 | 1 |
| ZnO | 1 | 1 |
| Sulfur | 0.5 | 0.5 |
| Accelerator, MBTS | 1.25 | 1.25 |

The comparative examples were tested for various physical properties, the results of which are outlined in Table 7. The data show that use of EXXPRO and the polybutene (Experimental 2) in the absence of process oil desirably improved (reduced) air permeability while maintaining or improving all other properties compared to Control 1. Cured compositions of the invention will have an air permeability of from less than 3.5×10⁻⁸ cm³·cm/cm²·sec·atm in one embodiment, less than 3.25×10⁻⁸ cm³·cm/cm²·sec·atm in another embodiment, less than 3.0×10⁻⁸ cm³·cm/cm²·sec·atm in one embodiment, and less than 2.75×10⁻⁸ cm³·cm/cm²·sec·atm in yet another embodiment when polybutene processing oil is present from 2 to 25 phr. In one embodiment, the number average molecular weight range of the useful polybutene processing oil ranges from 500 to 2500.

Mooney scorch, Ts2 cure time, tensile strength and aged tensile strength, and adhesion to NR carcass values for Experimental 2 were also improved (increased) compared to values for Control 1.

TABLE 7
Properties of Comparative and Experimental Compositions 1-2

| Properties | Control 1 | Expt 2 |
|---|---|---|
| Mooney Viscosity, ML (1 + 4) | 69 | 71 |
| 100° C. | | |
| Mooney Scorch MS@135° C., T5 | 10.2 | 12.4 |
| MDR Cure @180° C. | | |
| MH | 6.54 | 7.41 |
| ML | 1.29 | 1.54 |
| Ts2 | 1.48 | 1.71 |
| Tc50 | 1.65 | 2.01 |
| Tc90 | 2.69 | 3.38 |
| Stress/strain, original | | |
| Hardness Shore A | 50 | 53 |
| Modulus 100% | 1.8 | 2.2 |
| Modulus 300% | 5.9 | 7.0 |
| Tensile strength | 9.9 | 10.9 |
| Elongation at break | 725 | 690 |
| Stress/strain, aged 72 h@125° C. | | |
| Hardness Shore A | 59 | 59 |
| Modulus 100% | 3.3 | 3.7 |
| Modulus 300% | 8.8 | 9.6 |
| Tensile strength | 10.6 | 11.2 |
| Elongation at break | 497 | 464 |
| Air permeability @ 65° C. | 3.38 | 2.44 |
| Adhesion to Itself | 28.8 | 28.1 |
| Adhesion to NR carcass | 11.7 | 13.9 |

Compositions 1 and 2 were incorporated into a tire as the inner liners using automated building machines. All other tire components were normal production materials. Tires were press cured as is usual. Control 1 and Experimental 2 were incorporated into a P205/60 SR15 passenger tire. Tires were tested for inflation pressure retention (IPR) (Table 8). These data show that the addition of the polybutene to the tire innerliner composition, Experimental 2, improved (reduced) the respective air barrier qualities (IPR) compared to the tire without polybutene, Control 1. The Tire Durability of Experimental 2 was also improved (increased) compared to Control 1.

TABLE 8
Performance of Tires with Comparative and
Experimental Compositions 1-2

| Property | Control 1 | Expt 2 |
|---|---|---|
| Tire IPR | 1.94 | 1.52 |
| FMVSS 139 High Speed, to failure | 81.5 | 82.5 |
| FMVSS 139 Endurance, to failure | 74.8 | 153.2 |
| FMVSS 139 Low Inflation, to failure | 12.6 | 19.7 |

While the present invention has been described and illustrated by reference to particular embodiments, those of ordinary skill in the art will appreciate that the invention lends itself to many different variations not illustrated herein. For these reasons, then, reference should be made solely to the appended claims for purposes of determining the scope of the present invention. Further, certain features of the present invention are described in terms of a set of numerical upper limits and a set of numerical lower limits. It should be appreciated that ranges formed by any combination of these limits are within the scope of the invention unless otherwise indicated.

All priority documents are herein fully incorporated by reference for all jurisdictions in which such incorporation is permitted. Further, all documents cited herein, including testing procedures, are herein fully incorporated by reference for all jurisdictions in which such incorporation is permitted.

We claim:

1. A tire comprsing an innerliner, the innerliner made from at least one polybutene processing aid and at least one elastomer, the elastomer comprising C₄ to C₇ isoolefin derived units.

2. The tire of claim 1, wherein the polybutene processing aid has a number average molecular weight of from 900 to 8000.

3. The tire of claim 1, wherein the C₄ to C₇ isoolefin derived units are selected from isobutylene, isobutene, 2-methyl-1-butene, 3-methyl-1-butene, 2-methyl-2-butene, 1-butene, 2-butene, methyl vinyl ether, indene, vinyltrimethylsilane, hexene, 4-methyl-1-pentene, and mixtures thereof.

4. The tire of claim 1, wherein the at least one elastomer further comprises multiolefin derived units selected from isoprene, butadiene, 2,3-dimethyl-1,3-butadiene, myrcene, 6,6-dimethyl-fulvene, hexadiene, cyclopentadiene, piperylene, and mixtures thereof.

5. The tire of claim 1, wherein the at least one elastomer further comprises styrenic derived units selected from styrene, chlorostyrene, methoxystyrene, indene and indene derivatives, α-methylstyrene, o-methylstyrene, m-methylstyrene, and p-methylstyrene, and p-tert-butylstyrene.

6. The tire of claim 1, wherein the innerliner optionally comprises:
a) at least one filler selected from calcium carbonate, clay, mica, silica, silicates, talc, titanium dioxide, starch, wood flower, carbon black, or mixtures thereof;
b) at least one clay selected from montmorillonite, nontronite, beidellite, volkonskoite, laponite, hectorite, saponite, sauconite, magadite, kenyaite, stevensite, vermiculite, halloysite, aluminate oxides, hydrotalcite, or mixtures thereof, optionally, treated with modifying agents;
c) at least one processing oil selected from aromatic oil, naphthenic oil, paraffinic oil, or mixtures thereof;
d) at least one cure package or wherein the air barrier has undergone at least one process to produce a cured composition;
e) at least one secondary elastomer; or
f) any combination of a-e.

7. The tire of claim 1, wherein the innerliner has a MOCON (as herein defined) of 37.5 cc-mil/m²-day-mmHg or lower.

8. The tire of claim 1, wherein the innerliner has a MOCON (as herein defined) of 35.0 cc-mil/m²-day-mmHg or lower.

9. The tire of claim 1, wherein the innerliner has a MOCON (as herein defined) of 32.5 cc-mil/m²-day-mmHg or lower.

10. The tire of claim 1, wherein the innerliner has a MOCON (as herein defined) of 30.0 cc-mil/m²-day-mmHg or lower.

11. The tire of claim 1, wherein the tire has an Inflation Pressure Retention (IPR) (as herein defined) of 1.8 or lower.

12. The tire of claim 1, wherein the tire has an Inflation Pressure Retention (IPR) (as herein defined) of 1.6 or lower.

13. The tire of claim 1, wherein the tire has an Intracarcass Pressure (ICP) (as herein defined) of 75 or lower.

14. The tire of claim 1, wherein the tire has an Intracarcass Pressure (ICP) (as herein defined) of 70 or lower.

15. The tire of claim 1, wherein the tire has an Intracarcass Pressure (ICP) (as herein defined) of 65 or lower.

16. The tire of claim 1, wherein the tire has an Intracarcass Pressure (ICP) (as herein defined) of 60 or lower.

17. The tire of claim 1, wherein the tire has a Tire Durability (as herein defined) of 500 or higher.

18. The tire of claim 1, wherein the tire has a Tire Durability (as herein defined) of 550 or higher.

19. The tire of claim 1, wherein the tire has a Tire Durability (as herein defined) of 600 or higher.

20. A vehicle comprising at least one tire as defined in claim 1.
